(19) United States
(12) Patent Application Publication
(10) Pub. No.: US 2009/0103704 A1
(43) Pub. Date: Apr. 23, 2009

(54) VOICE INFORMATION PROCESSING DEVICE AND WIRING SYSTEM USING THE SAME DEVICE

(76) Inventors: Kousaku Kitada, Neyagawa-shi (JP); Keiichi Yoshida, Moriguchi-shi (JP); Yoshio Mitsutake, Kashiba-shi (JP); Yasushi Arikawa, Neyagawa-shi (JP); Hiroaki Takeyama, Kobe-shi (JP); Tomohiro Ota, Takarazuka-shi (JP); Hiroshi Kawada, Neyagawa-shi (JP); Shinya Kimoto, Higashiosaka-shi (JP); Manabu Nakata, Settsu-shi (JP); Yuya Hasegawa, Kyoto-shi (JP)

Correspondence Address: Cheng Law Group, PLLC, 1100 17th Street, N.W., Suite 503, Washington, DC, 20036, US

(21) Appl. No.: 12/093,946

(22) PCT Filed: Jan. 26, 2006
(86) PCT No.: PCT/JP2006/301221

§ 371 Date: May 15, 2008

(30) Foreign Application Priority Data
Nov. 25, 2005 (JP) 2005-341236
Nov. 25, 2005 (JP) 2005-341237
Nov. 25, 2005 (JP) 2005-341238
Nov. 25, 2005 (JP) 2005-341239
Nov. 25, 2005 (JP) 2005-341240
Nov. 25, 2005 (JP) 2005-341241
Nov. 25, 2005 (JP) 2005-341242
Nov. 25, 2005 (JP) 2005-341243
Nov. 25, 2005 (JP) 2005-341252
Dec. 22, 2005 (JP) 2005-371093
Dec. 22, 2005 (JP) 2005-371094
Dec. 22, 2005 (JP) 2005-371095
Dec. 22, 2005 (JP) 2005-371096

(51) Int. Cl. H04M 9/00

(52) U.S. Cl. 379/167.14

(57) ABSTRACT

A compact voice information processing device having excellent howling preventing effect, and a wiring system using the same device, which is excellent in function expandability and easy exchangeability, are provided. This processing device has a speaker, a first microphone disposed to face a diaphragm of the speaker, a second microphone disposed outside of an outer periphery of the diaphragm of the speaker, and a signal processing portion for removing an output voice component of the speaker mixed in an output of the second microphone by use of an output of the first microphone. This processing device is preferably used in a wiring system for transmitting information and electric power between plural locations in a building structure.

### TECHNICAL FIELD

The present invention relates to a voice information processing device preferably used for a communication apparatus such as an intercom system, and a wiring system using the same processing device.

### BACKGROUND ART

Intercom systems have been widely used as short-range communication means between rooms located away from each other in a building structure, and between an indoor space and an entrance of the building structure. In a conventional intercom system, an intercom device having a microphone, in which a transmitter's voice is input, and a speaker, from which a receiver's voice is output, is mounted on, for example, a wall surface of the building structure. Therefore, downsizing the device so as not to spoil the beauty of the wall surface is one of important subjects. On the other hand, when the microphone is placed close to the speaker, it is well known that a voice output of the speaker is received by the microphone, so that a howling phenomenon occurs. The howling phenomenon can be avoided by increasing a distance between the speaker and the microphone. However, it leads to an increase in size of the device. Thus, in the conventional intercom system, it seems to be difficult to simultaneously achieve preventing the howling phenomenon and downsizing the device.

For example, it is disclosed in Japanese Patent Early Publication No. 2004-320399 that a microphone is disposed at a center portion of a diaphragm of a speaker, and an acoustic signal generated from a front surface of the diaphragm of the speaker and an acoustic signal generated from a rear surface of the diaphragm are canceled out to each other, so that the sensitivity of the microphone to sound generated from the diaphragm is substantially lowered to prevent the howling phenomenon. However, it is difficult to completely cancel out, at the front of the microphone, the acoustic signal generated from the front surface of the diaphragm and the acoustic signal generated from the rear surface of the diaphragm. Therefore, a countermeasure of more effectively preventing the howling phenomenon is desired.

By the way, in the intercom system, which is adapted in use to be mounted on the wall surface of the building structure, an intercom device having a liquid display for displaying visual information as well as the voice information comes into practical use. For example, when such an intercom device is mounted once on the wall surface, and then a change of layout of the intercom device is performed, operations of installing the device to the wall surface and repairing the wall surface become necessary in addition to an electric wiring work. However, it is not easy for general users to perform these operations. Furthermore, the conventional intercom system usually has completed functions by itself. Therefore, when another function(s) is needed, the existing system must be exchanged with a new intercom system. In this case, as described above, the installing and repairing operations become necessary in addition to purchasing the new intercom system. These will impose a heavy economic burden on the user.

Thus, in the conventional intercom system adapted in use to be mounted on the wall surface, there are plenty of rooms for improvement from the viewpoints of achieving both of preventing the howling phenomenon and downsizing the device, and also providing function expandability and easy exchangeability.

### SUMMARY OF THE INVENTION

Therefore, in consideration of the above-described subjects, a primary concern of the present invention is to provide a new voice information processing device capable of preventing the howling phenomenon, while downsizing the device.

That is, the voice information processing device of the present invention comprises a speaker having a diaphragm for outputting voice information, a pair of first and second microphones each having a sound collecting portion, and a signal processing portion configured to process output signals from the first and second microphones. The first microphone is disposed to face the diaphragm of the speaker, and the second microphone is disposed outside of an outer periphery of the diaphragm of the speaker. The signal processing portion reduces an output voice component of the speaker contained in the output of the second microphone by use of the output of the first microphone.

According to the present invention, the first microphone disposed to face the diaphragm of the speaker can easily and efficiently collect a voice emitted from the speaker. Therefore, even when the voice output of the speaker is mixed in a voice input in the second microphone, the output voice component of the speaker can be effectively reduced or removed from the output of the second microphone by use of the voice signal collected by the first microphone. As a result, it is possible to effectively prevent the howling phenomenon. In addition, by executing the signal processing, the second microphone can be disposed close to the speaker without worrying about the occurrence of the howling phenomenon. Therefore, it is possible to simultaneously achieve a reduction in size of the device. The meaning of “reduce” used in the present description includes the case of removing the output voice component of the speaker mixed in the output of the second microphone, as a more preferred embodiment of the present invention.

It is preferred that the above voice information processing device further comprises a housing configured to accommodate therein the speaker and the first microphone, and having sound passing holes for providing the voice information output from the speaker to the outside. In this case, the speaker is disposed in the housing such that the diaphragm faces the sound passing holes, and the first microphone is held between the sound passing holes and the diaphragm such that the sound collecting portion faces the diaphragm, i.e., a front surface of the diaphragm. Alternatively, it is preferred that the speaker is disposed in the housing such that the diaphragm faces the sound passing holes, and the first microphone is disposed at a side opposite to the side facing the sound passing holes with respect to the diaphragm, i.e., such that the sound collecting portion faces a rear surface of the diaphragm.

The present invention is not limited to a specific microphone structure. From the viewpoint of downsizing the device, it is preferred that at least one of the first and second microphones comprises an acoustic sensor element, a voltage applying circuit configured to apply a bias voltage to the acoustic sensor element, an impedance conversion circuit configured to convert an electrical impedance of a microphone output, and an electromagnetic shield case for accommodating therein the acoustic sensor element, the voltage applying circuit and the impedance conversion circuit. In addition, as a preferred embodiment of the acoustic sensor element, it is preferred that the acoustic sensor element has a bare chip structure comprising a substrate, a lower electrode formed on the substrate, an insulating layer formed on the lower electrode, an upper electrode integrally formed with a vibrating portion having a plurality of apertures, and an electrode holding portion formed on the insulating layer to hold the upper electrode such that the vibrating portion is spaced away from the lower electrode by a clearance.

On the other hand, the present invention is not limited to a specific speaker structure. From the viewpoints of downsizing the device, and improving output efficiency, it is preferred that the speaker comprises a first magnet disposed such that a magnetic pole facing the diaphragm is either one of N and S poles thereof, a second magnet disposed around the first magnet so as to have a magnetic pole facing the diaphragm different from the magnetic pole facing the diaphragm of the first magnet, magnetic materials disposed on both end surfaces of the first magnet and the second magnet, and a voice coil accommodated in a groove formed at a position corresponding to a boundary portion between the first and second magnets in one of the magnetic materials, which is located between the diaphragm and the first magnet and the second magnet. In addition, it is preferred that the speaker has a third magnet, which is disposed between the first magnet and the second magnet such that a magnetic pole facing the first magnet of the third magnet is equal to the magnetic pole facing the diaphragm of the first magnet, and a magnetic pole facing the second magnet of the third magnet is equal to the magnetic pole facing the diaphragm of the second magnet, and the voice coil is accommodated in the groove formed above the third magnet in the one of the magnetic materials.

Alternatively, it is preferred that the speaker comprises a first multilayer magnet member formed in layers by a plurality of magnets, a second multilayer member formed in layers by a plurality of magnets, and disposed around the first multilayer magnet member through a groove, a bottom magnet disposed at a bottom of the groove between the first multilayer magnet member and the second multilayer magnet member, and a voice coil disposed in a top opening of the groove, and magnetic flux passes through the first multilayer magnet member, the bottom magnet, the second multilayer magnet member and the coil voice in a loop-like manner. In each of the speakers described above, when forming a ventilation hole penetrating through the magnet and the magnetic materials at a position facing a substantially center of the diaphragm, it is possible to reduce a stress occurring in the diaphragm due to air pressure variations during vibration of the diaphragm.

It is preferred that the signal processing portion of the voice information processing device of the present invention comprises a signal level adjusting means configured to perform a signal level adjustment between the output signals of the first and second microphones; a delay means configured to match phases of the output signals of the first and second microphones to each other according to a difference between a distance between the first microphone and the speaker and a distance between the second microphone and the speaker; and a calculation means configured to cancel out the output voice component of the speaker in the output signal of the second microphone by use of the output signals of the first and second microphones obtained through the signal level adjusting means and the delay means. In addition, it is preferred that the signal processing portion has a filtering means configured to extract only a signal of a predetermined voice band from each of the output signals of the first and second microphones. As a concrete embodiment of the signal level adjusting means, for example, the signal level adjusting means is an amplifying means configured to amplify the output signal of the second microphone to perform the signal level adjustment between the output signals of the first and second microphones. In this case, the calculation means can cancel out the output voice component by subtracting between the output signals of the first and second microphones obtained though the amplifying means and the delay means. Alternatively, the amplifying means may inversely amplify the output signal of the second microphone. In this case, the calculation means can cancel out the output voice component by adding the output signals of the first and second microphones obtained though the amplifying means and the delay means.

A further concern of the present invention is to provide a next-generation type wiring system using the above-described voice information processing device and having excellent function expandability and easy exchangeability, while achieving both of downsizing the device and preventing the howling phenomenon.

That is, the wiring system of the present invention comprises:

a base unit adapted in use to be mounted in a wall surface of a building structure, and connected to both of an electric power line and an information line installed in the building structure;

a function unit configured to provide at least one of functions of supplying electric power from the electric power line, outputting information from the information line, and inputting information into the information line when connected to the electric power line and the information line through the base unit; and

an intercom unit including the voice information processing device, the intercom unit being detachably connected to one of the function unit and the base unit, and comprising a power transmission means configured to enable power transmission with one of the base unit and the function unit, and a signal transmission means configured to enable signal transmission therewith,

wherein a voice signal provided from the signal transmission means is output from the speaker, and a voice signal input from the second microphone is sent to the information line through the signal transmission means.

According to the wiring system of the present invention, since the intercom unit can be detachably connected to one of the base unit and the function unit, a degree of freedom of layout of the intercom unit is improved, and the intercom unit can be easily exchanged without troublesome repair work. In addition, when the function unit to be connected is appropriately selected, it is possible to easily add a desired function to the wiring system with the intercom unit. Thus, comfortable and convenience living and working environments that meet the needs of individual users can be achieved by using the wiring system of the present invention having excellent in function expandability and easy exchangeability.

From the viewpoint of more effectively achieving function expandability and easy exchangeability, it is preferred that the power transmission means enables the power transmission between the intercom unit and one of the base unit and the function unit by means of electromagnetic coupling, and the signal transmission means enables voice signal transmission between the intercom unit and one of the base unit and the function unit by means of optical coupling. In particular, it is preferred that the intercom unit and one of the base unit and the function unit have a pair of a module port and a module connector, which are detachably connected to each other to simultaneously establish both of the power transmission therebetween and the signal transmission therebetween. In this case, since the power transmission and the signal transmission are respectively carried out in a non-contact manner by means of the electromagnetic coupling and the optical coupling, it is possible to provide reliable operation of the intercom unit, while reducing transmission loss of electric power and signal.

In addition, it is preferred that one of the module connector and the module port is formed at a side of the intercom unit such that the intercom unit is detachably connected to one of the base unit and the function unit in a direction along the wall surface. In this case, it is possible to obtain the function expandability of the wiring system without spoiling the beauty of the interior space.

In addition, it is preferred that the wiring system further comprises an additional function unit detachably connected to the function unit. The additional function unit is preferably configured to provide at least one of functions of supplying electric power from the electric power line, outputting information from the information line, and inputting information into the information line when connected to the electric power line and the information line through the base unit and the function unit. In this case, it is also preferred that the intercom unit is detachably connected at its one side to the function unit, detachably connected at the other side to the additional function unit, and has a second power transmission means configured to enable power transmission with the additional function unit, and a second signal transmission means configured to enable signal transmission therewith. The function expandability of the wiring system can be further improved by use of the additional function unit detachably connected to the intercom device.

Another concern of the present invention is to provide a power line communication type wiring system capable of providing substantially the same effects as the above-described wiring system.

That is, this wiring system comprises:

a base unit adapted in use to be mounted in a wall surface of a building structure, and connected to an electric power line installed in the building structure;

a function unit configured to provide at least one of functions of supplying electric power from the electric power line, outputting information carried by use of the electric power line, and inputting information to be carried into the electric power line when connected to the electric power line through the base unit; and

an intercom unit including the voice information processing device;

wherein at least one of the base unit, the function unit and the intercom unit has a transmitting and receiving means configured to enable transmitting and receiving of information signals by means of power line communication,

the intercom unit is detachably connected to one of the function unit and the base unit, and comprises a power transmission means configured to enable power transmission with one of the base unit and the function unit, and a signal transmission means configured to enable signal transmission therewith, and

when the intercom unit is connected to the electric power line through the base unit or through the base unit and the function unit, voice information received from the electric power line by the transmitting and receiving means is output from the speaker, and voice information input from the second microphone is transmitted in a power line communication manner through the transmitting and receiving means.

In addition, the wiring system of the present invention preferably has a coupling means for mechanically connecting the intercom unit with the base unit or the function unit. For example, the coupling means comprises a first engaging portion formed in one of the base unit and the function unit, a second engaging portion formed in the intercom unit, and a joining member configured to make a mechanical connection between the intercom unit and the one of the base unit and the function unit when a part of the joining member is engaged to the first engaging portion, and the remaining part of the joining member is engaged to the second engaging portion. Alternatively, it is preferred that the wiring system further comprises a cosmetic frame disposed along the wall surface, and having an opening, to which the intercom unit and the function unit are detachably attached. In this case, it is possible to prevent accidental falling of the intercom unit from the function unit or the base unit, and improve operation reliability of the wiring system.

Further characteristics of the present invention and advantages brought thereby will be clearly understood from the best mode for carrying out the invention described below.

### BRIEF EXPLANATION OF THE DRAWINGS

FIG. 1 is a perspective view of a voice information processing device according to a first embodiment of the present invention;

FIGS. 2A and 2B are cross-sectional views showing a positional relation between a speaker and a pair of microphones of the voice information processing device;

FIGS. 3A and 3B are respectively top and cross-sectional views of an acoustic signal/electric signal converting portion of the microphone;

FIG. 4A is a diagram showing a circuit configuration of the pair of microphones, and FIG. 4B is a diagram showing another circuit used for the microphones;

FIG. 5 is a plan view showing the positional relation between the speaker and the pair of microphones of the voice information processing device;

FIG. 6 is a diagram showing a circuit configuration of a signal processing portion of the voice information processing device;

FIGS. 7A and 7B are diagrams showing signal waveforms output from the pair of microphones;

FIGS. 8A and 8B are diagrams showing signal waveforms after performing a level adjustment to the signal waveforms of FIGS. 7A and 7B;

FIGS. 9A and 9B are diagrams showing signal waveforms after removing noises from the signal waveforms of FIGS. 8A and 8B;

FIGS. 10A and 10B are diagrams showing that a phase of the signal waveform of FIG. 9A is matched with the phase of the signal waveform of FIG. 9B by delaying the signal waveform of FIG. 9A with a delay circuit, and FIG. 10C is a diagram showing that the signal waveforms of FIGS. 10A and 10B are canceled to each other by an adding circuit;

FIG. 11 is a schematic diagram of a dual wiring system using the voice information processing device according to a second embodiment of the present invention;

FIG. 12 is a schematic circuit diagram of a base unit of the dual wiring system;

FIG. 13 is an exploded perspective view of the base unit;

FIG. 14 is a schematic circuit diagram of another base unit comprised of a gate housing and a main housing;

FIG. 15A is a perspective view of a switch box and the main housing of FIG. 14, and FIG. 15B is a plan view of a module port of the gate housing of FIG. 14;

FIG. 16 is a schematic circuit diagram of a function unit of the dual wiring system;

FIG. 17 is a schematic circuit diagram of an intercom unit of the dual wiring system;

FIG. 18 is a perspective view showing a state where the intercom unit is detachably connected to the base unit or the function unit;

FIG. 19 is a perspective view of the dual wiring system with the intercom unit having a display means;

FIG. 20 is a plan view of an attachment plate used to mount the base unit to the switch box;

FIG. 21 is a perspective view showing a connecting method of the intercom unit by use of a cosmetic frame;

FIG. 22A is an exploded perspective view showing a method of connecting the intercom unit to the base unit, and FIG. 22B is a perspective view of a joining member;

FIGS. 23A and 23B are front and side views of the intercom unit, and FIG. 23C is a perspective view showing how to use the joining member;

FIGS. 24A and 24B are front views of another intercom units;

FIGS. 25A and 25B are perspective views showing a connecting method between the intercom unit and the function unit;

FIGS. 26A to 26C are front and side views of still another intercom unit;

FIG. 27 is a schematic diagram of the intercom unit used for a power-line-communication type wiring system according to a third embodiment of the present invention;

FIG. 28A is a partially cut-away rear view of a speaker of a voice information processing device according to a fourth embodiment of the present invention, and FIG. 28B is a cross-sectional view taken along the line A-A of FIG. 28A;

FIGS. 29A and 29B are cross-sectional views showing a positional relation between the speaker and a pair of microphones of the voice information processing device according to the fourth embodiment;

FIGS. 30A and 30B are respectively exploded perspective and cross-sectional views of a speaker of a voice information processing device according to a fifth embodiment of the present invention;

FIGS. 31A to 31C are cross-sectional views showing modifications of the speaker of the fifth embodiment;

FIGS. 32A and 32B are respectively exploded perspective and cross-sectional views of a speaker of a voice information processing device according to a sixth embodiment of the present invention;

FIGS. 33A to 33C are cross-sectional views showing modifications of the speaker of the sixth embodiment;

FIGS. 34A and 34B are respectively exploded perspective and cross-sectional views of a speaker of a voice information processing device according to a seventh embodiment of the present invention;

FIGS. 35A to 35C are cross-sectional views showing modifications of the speaker of the seventh embodiment;

FIG. 36 is a cross-sectional view of a microphone used in a voice information processing device according to an eighth embodiment of the present invention;

FIG. 37 is a cross-sectional view showing another microphone of the eighth embodiment; and

FIG. 38 is a graph showing a relation between sensitivity and frequency of a microphone.

### BEST MODE FOR CARRYING OUT THE INVENTION

The voice information processing device of the present invention and the wiring system using the same device are explained below in detail according to preferred embodiments. That is, the first embodiment is directed to the voice information processing device according to a preferred embodiment of the present invention. The second and third embodiments are directed to wiring systems, which are the most appropriate applications of the voice information processing device of the present invention. The fourth to eighth embodiments are directed to preferred speaker and microphones available for the voice information processing device of the present invention.

### First Embodiment

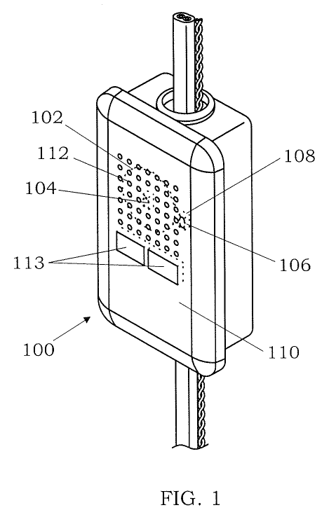

As shown in FIG. 1, the voice information processing device 100 of the present embodiment has a housing 110 for accommodating therein a speaker 102 having a diaphragm for outputting voice information; a pair of first and second microphones (104, 106) each having a sound collecting portion; and a signal processing portion 108 configured to process output signals of the first and second microphones. The voice information output from the speaker 102 is provided outside through sound passing holes 112 formed in the housing 110. In the drawings, the numeral 113 designates operation buttons for operating a communication state of the voice information processing device. Each of these components is explained below in detail.

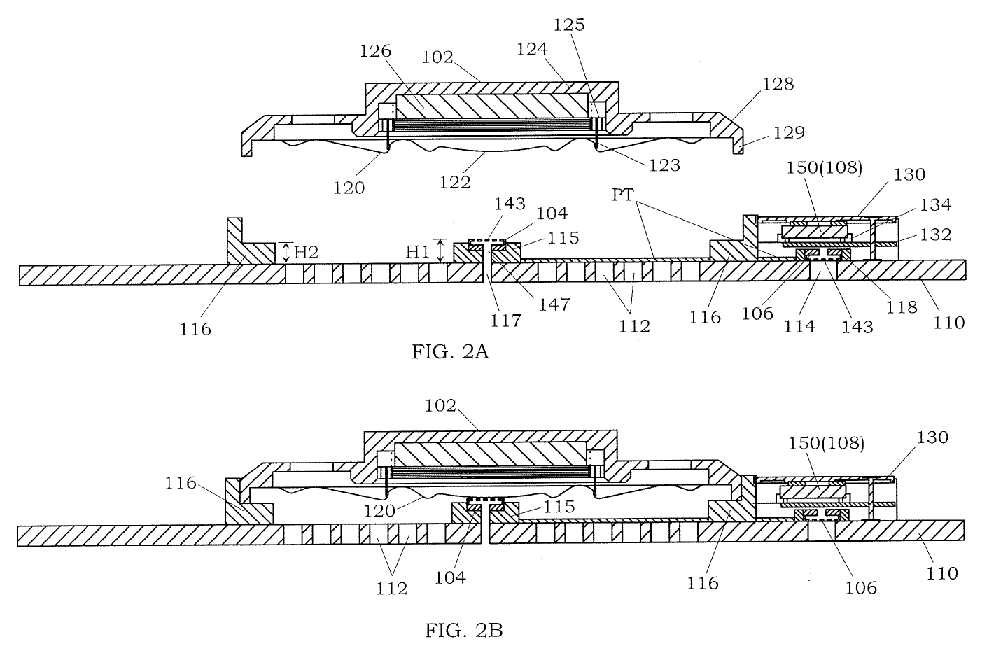

In the present embodiment, as shown in FIGS. 2A and 2B, the first microphone 104 is held between the sound passing holes 112 and the diaphragm 120 of the speaker 102 such that the sound collecting portion faces the diaphragm 120. The second microphone 106 is disposed outside of an outer periphery of the diaphragm 120 of the speaker 102 such that the sound collecting portion faces the outside through sound passing holes 114 for microphone.

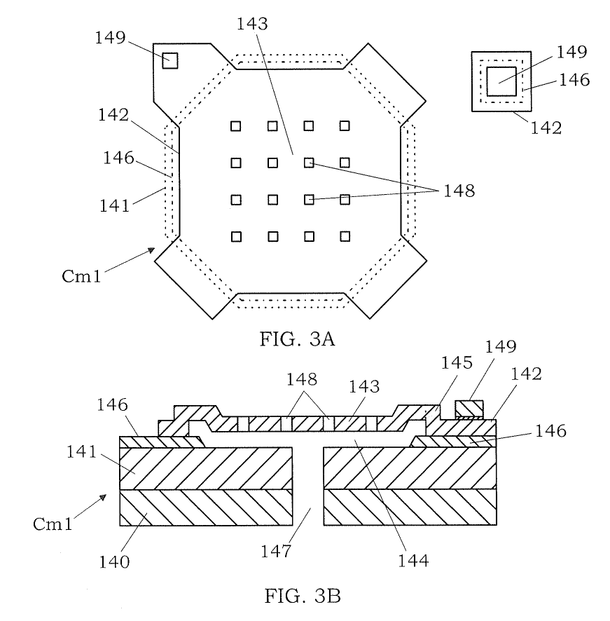

The first microphone 104 is a capacitor type silicon microphone. As shown in FIGS. 3A and 3B, an acoustic signal/electric signal converting portion Cm1 is composed of a substrate 140, a lower electrode 141 of a silicon substrate formed on the substrate 140, a vibrating portion 143, a supporting portion 145 formed in the vicinity of four corners of the outer circumference of the vibrating portion 143, an upper electrode 142 formed by a polysilicon film, a cavity 144 provided between the lower electrode 141 and the upper electrode 142, and an insulating layer 146 of a SiN film put between the lower electrode 141 and the upper electrode 142. The insulating layer 146 covers substantially the entire surface of the lower electrode 141 except for a region positioned almost directly below the vibrating portion 143 of the upper electrode 142 and a region used to connect a terminal to the lower electrode 141.

In the drawings, the numeral 147 designates a communication hole formed in the substrate 140 and the lower electrode 141 at a position facing a substantially center of the vibrating portion 143 such that the cavity 144 is communicated with the outside through the communication hole 147. Therefore, the communication hole 147 functions as an exhaust hole for reducing stress occurring in the microphone due to air pressure variations during vibration of the vibrating portion 143. The numeral 148 designates small apertures used to collect a voice, which are formed in the vibrating portion 143. In addition, a terminal 149 of an Au/TiW film connected with the upper electrode 142 is formed on the supporting portion 145. The above-described first microphone 104 has a bare-chip structure where an IC chip is directly mounted on the substrate 140 without using any package. This structure is preferred to reduce the thickness of the microphone. In the present embodiment, an acoustic/electric signal converting portion Cm2 of the second microphone 106 has the same bare-chip structure as the first microphone 104.

When vibrations corresponding to sound are applied from the outside to the microphone having the above configuration, the vibrating portion 143 of the upper electrode 142 vibrates to cause a change in distance between the vibrating portion and the lower electrode 141. Consequently, an electric current occurs due to a change in electrostatic capacity between the electrodes (141, 142).

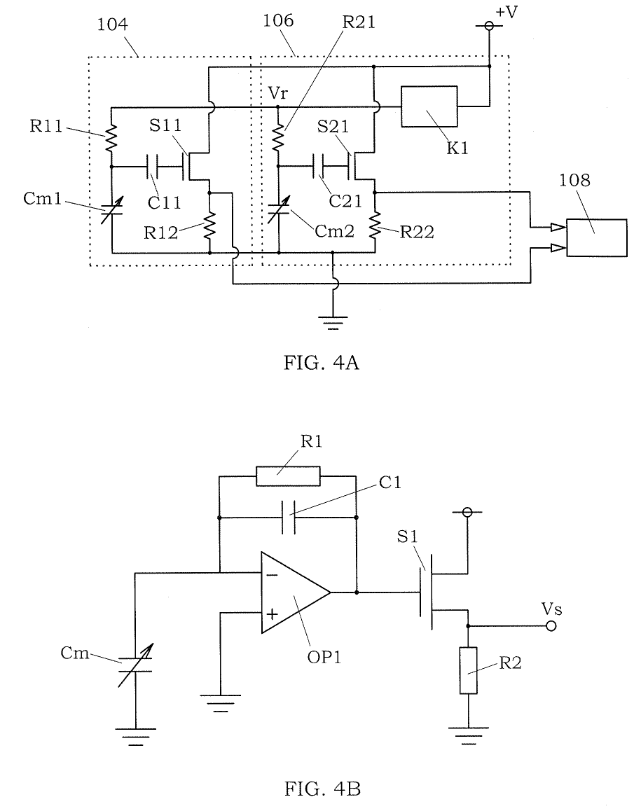

The electric current caused by the change in electrostatic capacity is converted into an electric voltage by a charge pump circuit, for example, a circuit shown in FIG. 4A, and then the voltage is output as a voice signal to the signal processing portion 108. That is, the second microphone 106 has a constant-voltage circuit K1, which is formed by a chip IC for converting an operating supply voltage +V (e.g., 5V) into a constant voltage Vr (e.g., 12V). In the first microphone 104, the constant voltage Vr is applied to a series circuit of a resistance Rh1 and an acoustic signal/electric signal converting portion Cm1. A connection midpoint between the resistance R11 and the acoustic signal/electric signal converting portion Cm1 is connected to a gate terminal of a J-FET element S11 (i.e., a Junction-type Field Effect Transistor) through a capacitor C11. A drain terminal of the J-FET element S11 is connected to the operating supply voltage +V, and a source terminal thereof is grounded through a resistance R12. In this regard, the J-FET element S11 is used for electrical impedance conversion. A voltage of the source terminal of this J-FET element S11 is output as the voice signal to the signal processing portion 108.

Similarly, in the second microphone 106, the constant voltage Vr is applied to a series circuit of a resistance R21 and an acoustic signal/electric signal converting portion Cm2. A connection midpoint between the resistance R21 and the acoustic signal/electric signal converting portion Cm2 is connected to a gate terminal of a J-FET element S21 (i.e., a Junction-type Field Effect Transistor) through a capacitor C21. A drain terminal of the J-FET element S21 is connected to the operating supply voltage +V, and a source terminal thereof is grounded through a resistance R22. In this regard, the J-FET element S21 is used for electrical impedance conversion. A voltage of the source terminal of this J-FET element S21 is output as the voice signal to the signal processing portion 108.

The J-FET element S11, the resistances (R11, R12) and the capacitor C11 are disposed in the vicinity of the acoustic signal/electric signal converting portion Cm1. Similarly, the J-FET element S21, the resistances (R21, R22) and the capacitor C21 are disposed in the vicinity of the acoustic signal/electric signal converting portion Cm2. In these cases, it is possible to suppress a reduction in S/N ratio of the voice signal output by each of the first and second microphones (104, 106).

Alternatively, a circuit for converting the output of the acoustic signal/electric signal converting portion (Cm1, Cm2) into a voltage signal, and then providing the voltage signal to the signal processing portion 108 may be provided by a circuit shown in FIG. 4B. This circuit has an operational amplifier OP1. An inverting input terminal of the operational amplifier OP1 is connected to the output side of the acoustic signal/electric signal converting portion Cm (i.e., the acoustic signal/electric signal converting portion Cm1 or Cm2). A parallel circuit of a resistance R1 and a capacitor C1 is connected between the inverting input terminal and an output terminal of the operational amplifier OP1. A non-inverting input terminal of the operational amplifier OP1 is connected to the ground level. The output terminal of the operational amplifier OP1 is connected to a gate terminal of a J-FET device S1 (i.e., Junction-type Field Effect Transistor), and a source terminal of the J-FET device is connected to the ground through a resistance R2. In this regard, the J-FET device S1 is used for impedance conversion. A voltage of the source terminal of this J-FET device S1 is output as the voice signal to the signal processing portion 108. When Vs is the voltage of the source terminal of this J-FET device S1, and Q is the electric charge amount of the acoustic signal/electric signal converting portion Cm, Vs=−Q/C1. The resistance R1 is a resistance for stabilizing the DC level of the output.

It is preferred that each the first and second microphones (104, 106) is a chip of so-called MEMS (micro electro mechanical system), which is obtained by micromachining of a silicon substrate.

As shown in FIGS. 2A and 2B, the first microphone 104 is held by a rectangular frame rib 115 formed on an inner surface of a front wall having sound passing holes 112 of the housing 110. The rib 115 is disposed to face a center cap 122 of a dome-like diaphragm 120 of the speaker described later. The first microphone 104 is positioned in such a state that the vibrating portion 143 (the sound collecting portion) faces the center cap 122. A height H1 from the inner surface of the front wall of the housing 110 to an upper surface of the first microphone 104 disposed in the rib 115 is substantially equal to a height H2 from the inner surface of the front wall of the housing 110 to a holding surface of a speaker holding rib 116. Thereby, a gap between the first microphone 104 and the diaphragm 120 of the speaker 102 can be set at minimum. In addition, an aperture 117 (e.g., φ0.5 mm), which functions as a ventilation hole during the vibration of the vibrating portion 143, is formed in the rib 115 and the front wall of the housing 110 so as to communicate with the communication hole 147 of the first microphone 104. By using this structure, a voice output from the speaker 102 can be reliably collected by the first microphone 104.

In addition, the second microphone 106 is disposed in a case 130, which is formed at a side of the speaker on the inner surface of the front wall of the housing 110, so as not to face the diaphragm 120 of the speaker 102. In addition, the position of the vibrating portion (the sound collecting portion) 143 is determined by a rectangular frame rib 118 to face the inner surface of the front wall of the housing 110. A partition plate 132 is formed to extend from an inner side surface of the case 130 toward the backward of the second microphone 106. A rib 134 having an L-shaped cross section is formed on a rear surface of the partition plate 132. An IC package 150 including the signal processing portion 108 is mounted on this rib 134. The IC package 150 is positioned such that a rear surface of the IC package contacts an inner surface of the case 130.

The second microphone 106 is electrically connected to the IC package 150 through a conductive pattern PT formed on the inner surface of the housing 110. A method of forming the conductive pattern PT is briefly explained below. In the present embodiment, the conductive pattern PT is formed by using MID (Molded Interconnect Device) technology. That is, a plating undercoat electrode of a conductive thin film is formed at a region including a portion for forming the conductive pattern PT on the inner surface of the front wall of the housing 110 made of a synthetic resin. In this regard, the plating undercoat electrode does not need to have the same pattern as the conductive pattern PT. That is, it is essential to cover the entire portion for forming the conductive pattern PT with the conductive thin film. Then, the plating undercoat electrode is patterned by means of laser irradiation such that the portion corresponding to the conductive pattern PT is isolated from the other portion. That is, a part of the plating undercoat electrode is removed along a profile line defining the conductive pattern PT. Next, the thickness of the plating undercoat electrode on the portion for forming the conductive pattern PT is increased by electroplating. Finally, the conductive thin film other than the conductive pattern PT is removed by etching. In this case, it is possible to form a fine conductive pattern PT by use of the laser irradiation. In addition, there are advantages of reducing the number of parts, and simplifying the device structure, as compared with the case of individually forming wirings for power supply and signal transmission.

In addition, when the first microphone 104 is formed on a MID substrate, which is obtained by forming three-dimensional wirings on the inner surface of the housing 110 according to the MID technology, a further integration of the compact microphone can be achieved. As the second microphone 106, a plurality of microphones may be disposed, if necessary.

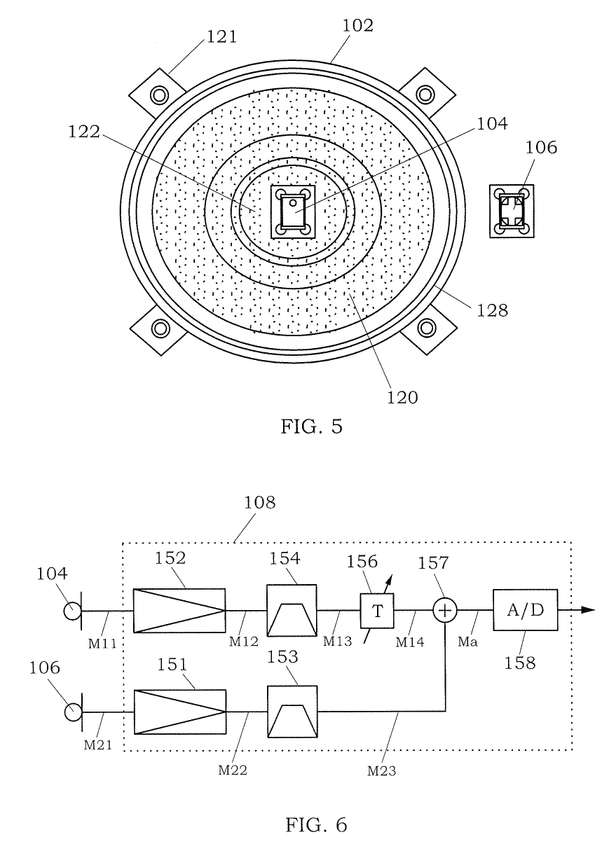

Next, the speaker 102 is explained. As shown in FIGS. 2A and 2B, the speaker 102 has a cylindrical yoke 124 having an opening at its one end, which is formed by use of an iron-based material having a thickness of 0.8 mm such as cold-reduced carbon steel sheets (SPCC, SPCEN) and an electromagnetic soft iron (SUY). In the cylindrical yoke 124, a columnar permanent magnet 126 (e.g., remnant flux density 1.39T˜1.43T) made of neodymium is disposed. As shown in FIG. 5, the yoke 124 is disposed inside of a holding member 128 having a circular ring-like shape, and an outer peripheral portion of the dome-like diaphragm 120 is fixed to the holding member 128. The diaphragm 120 can be formed by use of a thermoplastic resin material (e.g., thickness 12 μm˜35 μm) such as PET(PolyEthyleneTerephthalate) and PEI(Polyetherimide). A tubular bobbin 123 is fixed to a rear surface of the diaphragm 120. By winding a polyurethane copper wire (e.g., φ0.05 mm) around this bobbin 123, a voice coil 125 is obtained. The bobbin 123 and the voice coil 125 are disposed in the vicinity of the opening of the yoke 124 to be vibratable in a direction substantially perpendicular to the paper surface of FIG. 5.

When a voice signal is input in the polyurethane copper wire of the voice coil 125, an electromagnetic force occurs in the voice coil 125 due to the electric current of this voice signal and the magnetic field of the permanent magnet 126. This electromagnetic force vibrates the bobbin 123 with the diaphragm 120. As a result, a voice corresponding to the voice signal is output from the diaphragm 120. As an example, the speaker has a diameter of 20 to 25 mm, and a thickness of about 4.5 mm.

As described above, the rib 116 having an L-shaped cross section is formed in a ring-like shape on the inner surface of the front wall of the housing 110 facing the diaphragm 120 of the speaker 102. A projecting portion of the rib 116 is fitted to an outer surface of a convex portion 129 extending from an outer peripheral end portion of the holding member 128 of the speaker 102 toward the forward side. Thereby, the speaker 102 can be positioned such that the diaphragm 120 is in a face-to-face relation with the inner surface of the front wall of the housing 110. At this time, a space for accommodating the first microphone 104 is defined between the diaphragm 120 of the speaker 102 and the inner surface of the housing 110. As shown in FIG. 5, the speaker 102 has four attachment pieces 121, which are formed on the outer peripheral portion at locations equally spaced away from each other in the circumferential direction. The speaker 102 is mounted on the inner surface of the housing 110 by use of screws and through holes formed in the attachment pieces 121.

As shown in FIG. 6, the signal processing portion 108 accommodated in the IC package 150 comprises an amplifying portion 152 for amplifying an output of the first microphone 104 in a non-inverting manner, a bandpass filter 154 for removing frequency noises other than a voice band (300˜4000 Hz) from an output of the amplifying portion 152, a delay circuit 156 for delaying an output of the bandpass filter 154, an amplifying portion 151 for amplifying an output of the second microphone 106 in an inverting manner, a bandpass filter 153 for removing frequency noises other than the voice band (300˜4000 Hz) from an output of the amplifying portion 151, an adder circuit 157 for adding an output of the bandpass filter 153 to an output of the delay circuit 156, and an A/D converting circuit 158 for converting an analog signal output from the adder circuit 157 into a digital signal. The delay circuit 156 can be constructed by a time delay element or a CR phase-delay circuit.

In FIG. 6, the voice signal is obtained from the A/D converting circuit 158 formed at the output side of the signal processing portion 108 to convert the analog signal to the digital signal. The A/D converting circuit may be provided at the output side of each of the bandpass filters (153, 154). In this case, since the subsequent processing is performed to digital signals, there is an advantage that the operation of the delay circuit 156 becomes easy.

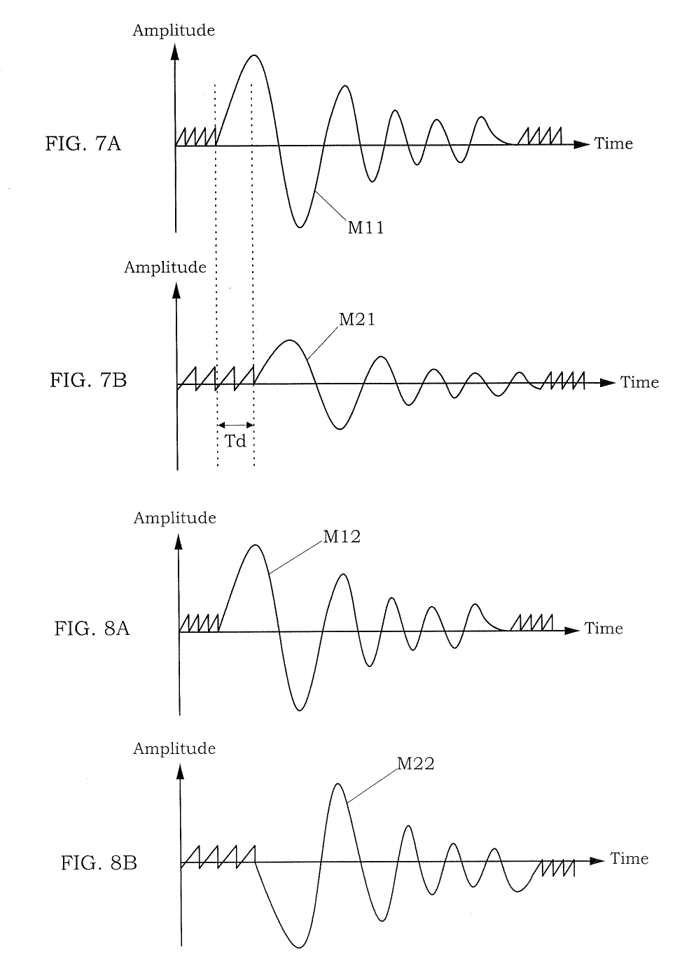

It is explained below about an operation of the signal processing portion 108. First, when X1 is a distance between a center of the speaker 102 and a center of the first microphone 104, which is disposed substantially in front of the center of the speaker 102, and X2 is a distance between the center of the speaker 102 and a center of the second microphone 106, which is disposed outside of the circumference of the speaker 102, X1 is smaller than X2, i.e., (X1<X2). Therefore, when the voice output from the speaker 102 is collected by the first and second microphones (104, 106), the output M21 (FIG. 7B) of the second microphone 106 is smaller in amplitude than the output M11 (FIG. 7A) of the first microphone 104, as shown in FIGS. 7A and 7B. In addition, the phase of the output M21 of the second microphone 106 is delayed by a delay time Td (=(X2−X1)/Vs), wherein Vs is sound velocity, and (X2−X1) is a difference between the distance between the speaker 102 and the second microphone 106 and the distance between the speaker 102 and the first microphone 104.

Next, a level adjustment is performed according to the difference (X2−X1) between the distance between the microphone 104 and the speaker 102 and the distance between the microphone 106 and the speaker 102 such that output levels of the both microphones (104, 106) are substantially equal to each other with respect to the voice output from the speaker 102. That is, as shown in FIG. 8A, the amplifying portion 152 generates the output M12 by amplifying the output M11 in the non-inverting manner, and as shown in FIG. 8B, the amplifying portion 151 generates the output M22 by amplifying the output M21 in the inverting (180° inverted) manner. In the present embodiment, an amplifying rate of the amplifying portion 152 is substantially 1. Therefore, the amplifying portion 152 may be omitted.

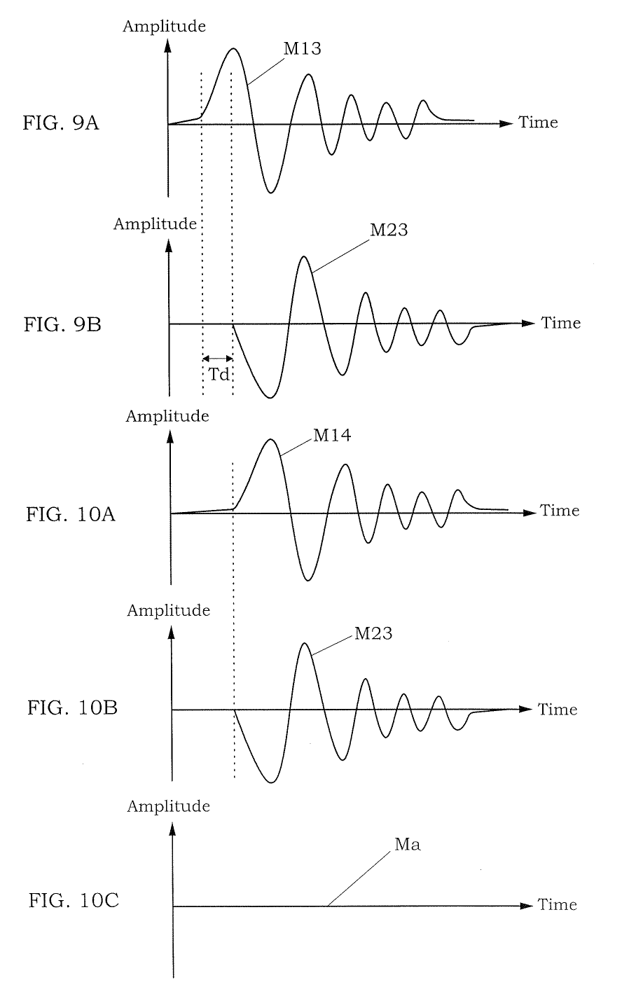

Next, the bandpass filters (154, 153) remove the frequency noises other than the voice band from the outputs (M12, M22) to generate the outputs (M13, M23) shown in FIGS. 9A and 9B.

Next, as shown in FIGS. 10A and 10B, the delay circuit 156 delays the output of the first microphone 104 disposed close to the speaker 102 by the delay time Td such that the output M14 of the delay circuit 156 has the same phase as the output M23 of the bandpass filter 153. Then, a sum of the thus obtained outputs (M14, M23) is calculated by the adder circuit 157. As a result, it is possible to cancel out the signal component corresponding to the voice output from the speaker 102, as shown in FIG. 10C, and obtain an output Ma. In the case of performing non-inverting amplification at the amplifying portion 151, as in the amplifying portion 152, the signal component corresponding to the voice output from the speaker 102 can be canceled out by performing the delaying step after the amplifying steps, and then calculating a subtraction between the output signals of the first and second microphones (104, 106).

In addition, the delay circuit 156 may detect a phase difference between the output M13 shown in FIG. 9A of the first microphone 104 and the output M23 shown in FIG. 9B of the second microphone 106, and delay the phase of the output M13 by the detected phase difference. At this time, the difference (X2−X1) between the distance between the center of the speaker 102 and the center of the second microphone 106 and the distance between the center of the speaker 102 and the center of the first microphone 104 is set such that the phase difference between the outputs (M13, M23) is larger than 0°, and smaller than 90°. Thus, since the phase of the output M13 is delayed within the range of from 0° to 90° by the delay circuit 156, the phase difference can be easily determined, and phases of the outputs are accurately matched with each other.

With respect to a voice (communication voice) provided from the forward side of the voice information processing device 100, a sound pressure of the second microphone 106, which is disposed such that the vibrating portion (the sound collecting portion) 143 faces the outside through the sound passing holes 114, is larger than the sound pressure of the first microphone 104, which is disposed such that the vibrating portion (the sound collecting portion) 143 faces the diaphragm 120 of the speaker 102. In addition, the output M21 of the second microphone 106 is larger in output level than the output M11 of the first microphone 104. Furthermore, since the amplification rate of the amplifying portion 151 is larger than that of the amplifying portion 152, the output M22 of the amplifying portion 151 is further increased than the output M12 of the amplifying portion 152. Therefore, the output corresponding to the voice is obtained in the output Ma of the adder circuit 157. Thus, the signal component corresponding to the voice output from the speaker 102 is not included in the output Ma of the adder circuit 157, and only the signal component corresponding to the voice provided from the outside toward the sound collecting portion of the second microphone 106 can be extracted.

According to the above-described configuration, it is possible to prevent the howling phenomenon, which is caused when the voice output of the speaker 102 is picked up by the microphone 106. In addition, since a large distance between the speaker 102 and the microphone 106 is not needed, it is possible to downsize an intercom device having the voice information processing device of the present invention.

### Second Embodiment

The wiring system of the present embodiment uses an intercom unit having the voice information processing device of the first embodiment as one of the components. In addition, electric power and information signals are respectively transmitted by use of a power supply line and an information line, which are installed in a building structure. Therefore, this wiring system of the present embodiment is called as “dual wiring system”.

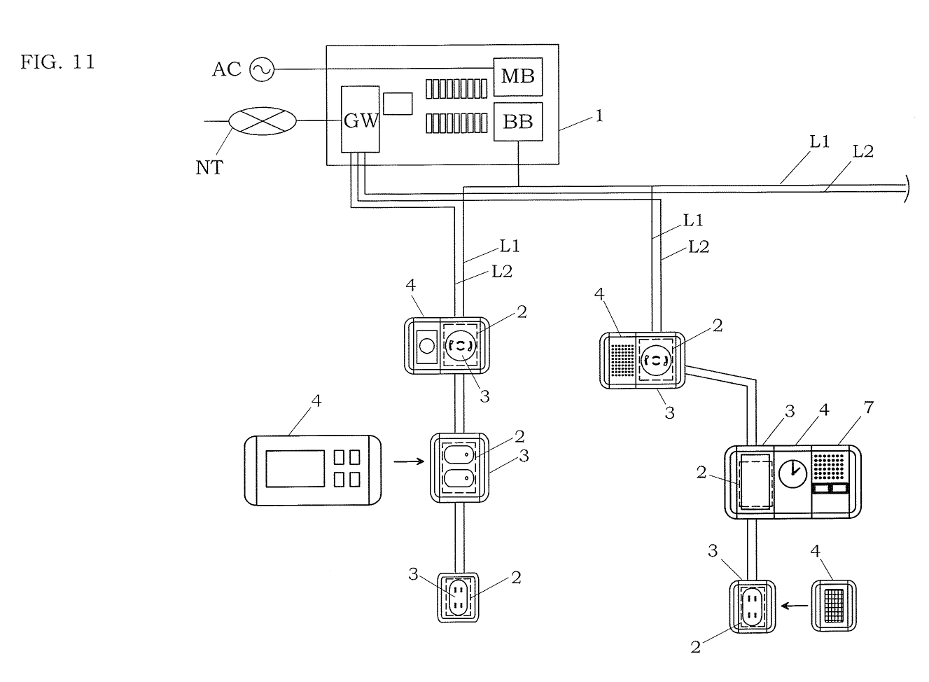

That is, as shown in FIG. 11, the dual wiring system of this embodiment has the power supply line L1 and the information line L2 installed in the building structure, which are connected to commercial power source AC and the Internet network NT through a distribution board 1, a plurality of switch boxes 2 embedded in wall surfaces at plural places of the building structure, a plurality of base units 3 mounted in the switch boxes and connected to the power supply line L1 and the information line L2, function units 4 each having the capability of providing at least one of functions of supplying electric power from the power supply line L1, outputting information from the information line L2 and inputting information into the information line L2 when connected to the power supply line L1 and the information line L2 through one of the base units 3, and an intercom unit 7 detachably connected to the base unit 3 and/or the function unit 4 and incorporating the voice information processing device of the present invention. In the present description, the term “wall” is not limited to a sidewall formed between adjacent rooms. That is, the wall includes exterior and interior walls of the building structure, and the interior wall includes sidewalls, ceiling and floor. In FIG. 1, “MB” designates a main breaker, “BB” designates a branched breaker, and “GW” designates a gateway (e.g., router or built-in hub).

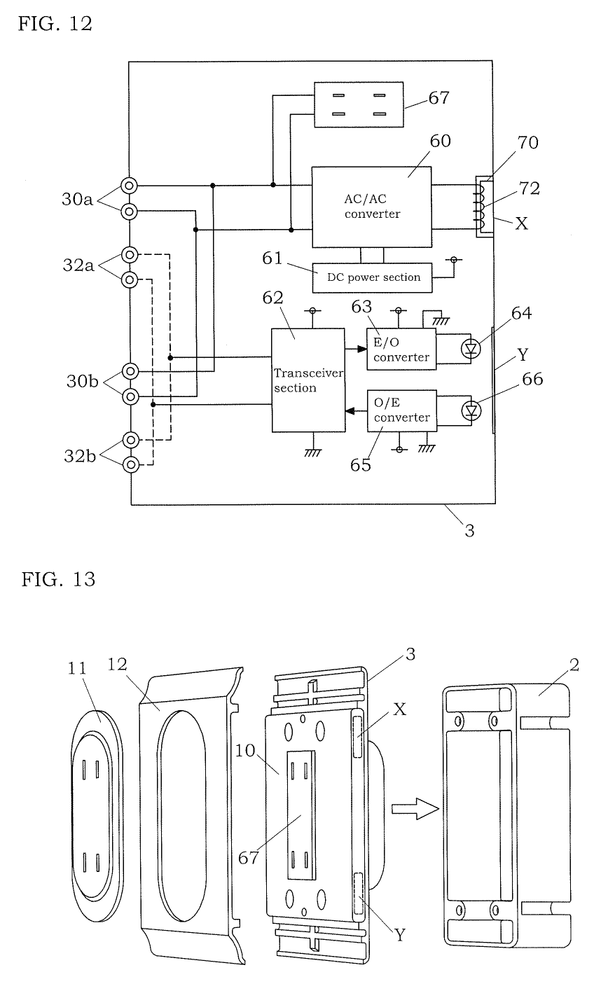

As shown in FIG. 12, each of the base units 3 has terminals (30a, 32a) connected to the power supply line L1 and the information line L2, and bus-wiring terminals (30b, 32b) at its rear surface. As shown in FIG. 13, the base unit 3 is fixed to the switch box 2 by use of a fastening member such as screws. In FIG. 13, the numeral 12 designates a cosmetic cover detachably attached to a front surface of the base unit 3, and the numeral 11 designates a receptacle cover separately formed from the cosmetic cover 12. A circuit configuration provided in the base unit 3 is designed in consideration of the transmission of electric power and information signals to the function unit 4 or the intercom unit 7. For example, the base unit 3 of FIG. 12 has an AC/AC converter 60, DC power section 61, transceiver section 62, E/O converter 63, O/E converter 65, and a function section 67.

The AC/AC converter 60 converts commercial AC power into a low AC voltage having an increased frequency, and applies the low AC voltage to a coil 72 wound around a core 70. The DC power section 61 generates an operating voltage for internal circuit components from a stable DC voltage obtained by rectifying and smoothing the low AC voltage. The transceiver section 62 transmits and receives the information signals to enable interactive communication through the information line L2. The E/O converter 63 converts the information signals received from the information line L2 into optical signals, and outputs the optical signals though a light emitting device (LED) 64. On the other hand, the O/E converter 65 receives optical signals provided from the outside, e.g., the intercom unit 7 or the function unit 4 by a light receiving device (PD) 66, converts the received optical signals into the information signals, and transmits the information signals to the transceiver section 62. In the present embodiment, the function section 67 is provided by a power receptacle. If not needed, the function section 67 may be omitted.

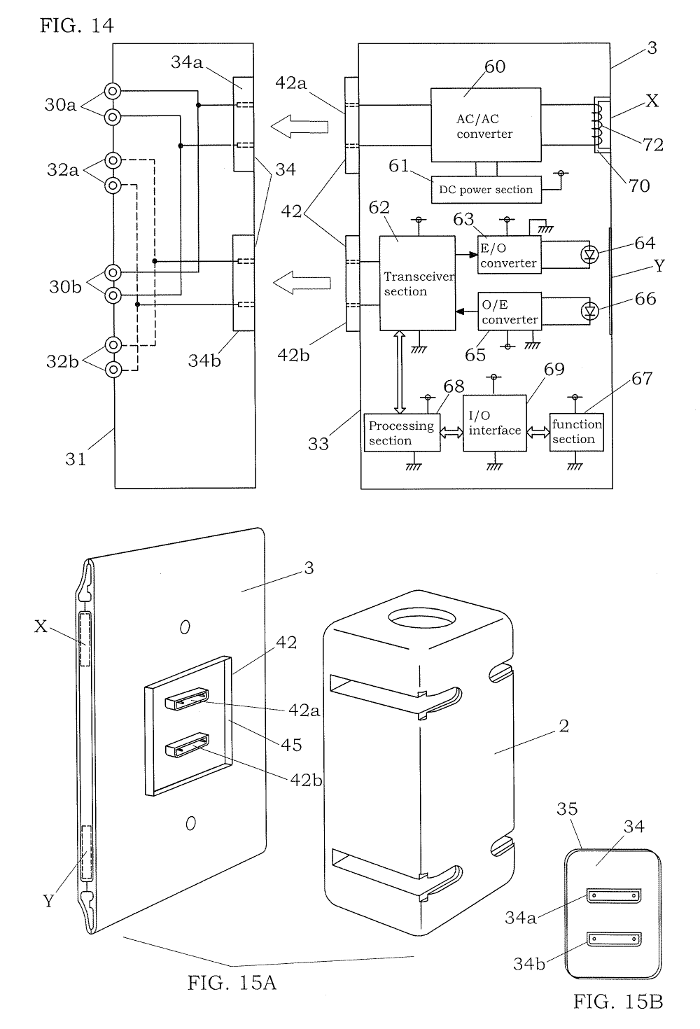

In addition, another base unit 3 shown in FIG. 14 may be used. This base unit 3 is formed with a gate housing 31 made of a synthetic resin and having terminals (30a, 32a, 30b, 32b) connected to the power supply line L1 and the information line L2, and a main housing 33 made of the synthetic resin and detachably connected to the function unit 4. The gate housing 31 and the main housing 33 respectively have a module port 34 and a module connector 42, which are detachably connected to each other to simultaneously establish both of the supply of electric power from the gate housing 31 to the main housing 33, and the signal transmission therebetween. In place of the main housing 33, the function unit 4 having the module connector 42 may be detachably connected to the module port 34 of the gate housing 31. In this case, the gate housing 31 having the module port 34 can be regarded as the base unit.

As shown in FIG. 15B, the module port 34 formed at the front surface of the gate housing 31 is provided with an electric power port 34a for supplying the electric power and an information signal port 34b for accessing the information line L2. In the dual wiring system, the module port 34 is standardized (normalized) with respect to the arrangement and shapes of the electric power port 34a and the information signal port 34b. For example, as shown in FIG. 15B, each of the electric power port 34a and the information signal port 34b is configured in a substantially rectangular shape, and they are arranged in parallel to each other.

On the other hand, as shown in FIGS. 14 and 15A, the module connector 42 formed at the rear surface of the main housing 33 is provided with an electric power connector 42a and an information signal connector 42b. In the dual wiring system, the module connector 42 is standardized (normalized) with respect to the arrangement and shapes of the electric power connector 42a and the information signal connector 42b. For example, as shown in FIG. 15A, each of the electric power connector 42a and the information signal connector 42b is configured in a substantially rectangular shape, and they are arranged in parallel to each other.

In this embodiment, the module port 34 has a guide portion 35 such as a ring-like wall or a ring-like groove extending around the electric power port 34a and the information signal port 34b. This guide portion 35 is formed to be engageable to an engaging portion 45 such as a ring-like wall of the module connector 42, which is formed on the rear surface of the main housing 33. Since the electric power connector 42a and the information signal connector 42b are simultaneously connected to the electric power port 34a and the information signal port 34b by simply engaging the engaging portion 45 to the guide portion 35, it is possible to improve easy exchangeability and connection reliability of the main housing 33. This configuration is also available for the function unit 4 having the module connector 42. The module port 34 and the module connector 42 may be formed by female and male connectors.

In addition, the base unit 3 of FIG. 14 is designed to have a sensor function or a controller function as the function section 67. In addition, a processing section 68 such as CPU and an I/O interface 69 are formed between the transceiver section 62 and the function section 67. The processing section 68 has functions of performing signal processing of the information signals received by the transceiver section 62 to transmit the processed signals to the function section 67 through the I/O interface 69, and receiving data signals provided from the function section 67 to output it as the information signals. Electric power needed to energize the transceiver section 62, the processing section 68 and the function section 67 is supplied from the DC power section 61. When an AC/DC converter for converting the commercial AC voltage into a required DC voltage is used in place of the AC/AC converter 60, the DC power section 61 can be omitted. Other circuit configurations of FIG. 14 are substantially the same as those of FIG. 12, and therefore duplicate explanations are omitted.

The function unit 4 is designed to provide various kinds of functions by using the electric power supplied through the base unit 3 and the interactive communication of the information signals with the information line L2 through the base unit 3. For example, when the function unit 4 is connected to the base unit 3 mounted in the wall surface at a relatively high position near the ceiling, it preferably has a receptacle function of receiving a plug with hook of a lighting apparatus, a security function such as a temperature sensor, a motion sensor or a monitoring camera, or an audio function such as a speaker. In addition, when the function unit 4 is connected to the base unit 3 mounted in the wall surface at a middle position, at which the function unit 4 can be easily operated by the user, it preferably has a switch function of turning on/off the lighting apparatus, a controller function for an electric appliance such as air-conditioning equipment, or a display function such as a liquid crystal display. In addition, when the function unit 4 is connected to the base unit 3 mounted in the wall surface at a low position near the floor, it preferably has a receptacle function for receiving a plug of an electric appliance such as an electric vacuum cleaner, an audio function such as a speaker, or a footlight function.

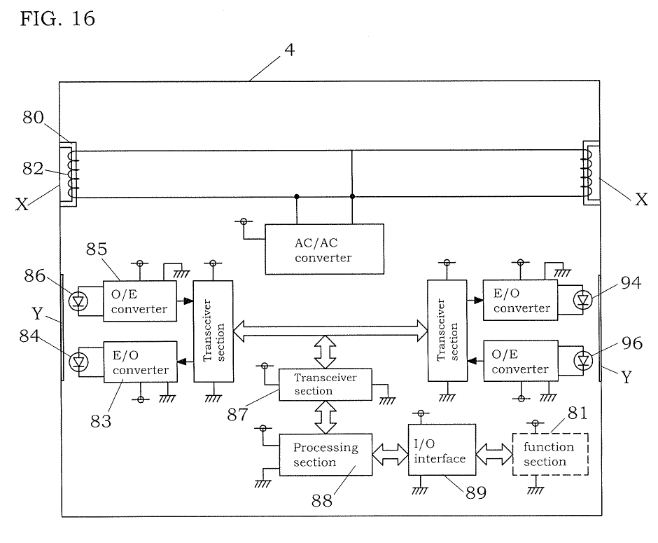

Specifically, as shown in FIG. 16, when a function section 81 of the function unit 4 is formed by the switch, operation data obtained by operating the switch is transmitted to a processing section 88 through an I/O interface 89. Then, the processed data is sent to, for example, an infrared remote controller (not shown) through a transceiver section 87, so that an electric appliance to be controlled is turned on/off by receiving a remote control signal emitted from the infrared remote controller. Alternatively, when the function section 81 is formed by the sensor, data detected by the sensor is transmitted as the information signals to the information line L2, and then informed to the user by a required communicator. In addition, when the function section 81 is formed by the monitoring camera, compression encoding of image data taken by the monitoring camera is performed, and then output as the information signals. Furthermore, when the function section 81 is formed by a monitor, image data provided through the information line L2 is decoded, and then displayed on the monitor through the I/O interface 89. When the function section 81 is simply formed by the power receptacle, the processing section 88 and the I/O interface 89 can be omitted. Thus, since the function units 4 having various kinds of function sections 81 can be detachably used in the dual wiring system, it is possible to increase the degree of freedom of layout of the function units 4, and set the layout of the function units according to the individual user's needs.

The coil 72 wound around the core 70 in the base unit 3 shown in FIGS. 12 and 14 is used as a power supply means for supplying electric power from the base unit 3 to the function unit 4 in a non-contact manner. That is, the coil 72 wound around the core 70 of the base unit 3 provides an electromagnetic coupling portion corresponding to a first side of a transformer. On the other hand, as shown in FIG. 16, the function unit 4 has an electromagnetic coupling portion comprised of a coil 82 wound around a core 80, which corresponds to a second side of the transformer. Therefore, by making electromagnetic coupling between the base unit 3 and the function unit 4, a low AC voltage is induced in the coil 82 of the function unit 4 to achieve the supply of electric power from the base unit 3 to the function unit 4. In this embodiment, since the low AC voltage having the higher frequency than the commercial AC voltage is obtained by the AC/AC converter 60, the electromagnetic coupling portion used as the transformer can be downsized.

In addition, the light emitting device (LED) 64 of the E/O converter 63 of the base unit 3 is used to transmit optical signals as the information signals to the function unit 4 in a non-contact manner. In this case, a light receiving device (PD) 86 is disposed in the function unit 4 such that the light emitting device 64 of the base unit 3 is in a face-to-face relation with the light receiving device 86 of the function unit 4 when the function unit 4 is connected to the base unit 3. Similarly, to transmit the optical signals as the information signals from the function unit 4 to the base unit 3, the function unit 4 has a light emitting device (LED) 84, which is disposed in the face-to-face relation with the light receiving element (PD) 66 of the base unit 3 when the function unit 4 is connected to the base unit 3. Thus, each of the base unit 3 and the function unit 4 has a pair of the E/O converter (63, 83) and the O/E converter (65, 85) as an optical coupling portion for enabling the interactive communication of the information signals therebetween.

As shown in FIGS. 12 and 13, the electromagnetic coupling portion X used for the supply of electric power and the optical coupling portion Y used for the interactive communication of the information signals are disposed at a side surface of the base unit 3 so as to be spaced from each other by a required distance. The shapes of the electromagnetic coupling portion X and the optical coupling portion Y are stylized (normalized) such that each of the base units 3 is shared by the plural function units 4. In addition, it is preferred that the pair of the electromagnetic coupling portion X and the optical coupling portion Y are provided at each of both sides of the function unit 4, as shown in FIG. 16. That is, the optical coupling portion Y formed at one side (e.g., left side) of the function unit 4 is composed of the light receiving device 86 located at the upper side and the light emitting device 84 located at the lower side, and the optical coupling portion Y formed at the opposite side (e.g., right side) of the function unit 4 is composed of a light emitting device 94 located at the upper side and a light receiving device 96 located at the lower side.

In this case, one side of the function unit 4 is used to connect with the base unit 3, and the other side of the function unit 4 is used to connect with another function unit 4 (e.g., additional function unit shown in FIG. 19). Therefore, it becomes possible to ensure the interactive communication of the information signals when plural function units 4 are connected to the base unit 3 in series. It is also preferred that a light transparent cover is attached to the respective optical coupling portion Y to protect the optical devices. As shown in FIG. 16, the function unit 4 has circuit components for achieving the supply of electric power and the interactive communication of the information signals with an adjacent function unit 4. These circuit components are substantially the same as those of the base unit 3, and therefore duplicate explanations are omitted.

As shown in FIG. 13, when the function section 67 (e.g., power receptacle) is formed at the front surface of the base unit 3, and the pair of the electromagnetic coupling portion X and the optical coupling portion Y are provided at the side surface of the base unit 3, the function unit 4 can be connected to the base unit 3 along the wall surface (i.e., in substantially parallel with the wall surface). Therefore, it is possible to improve function expandability in the dual wiring system without spoiling the beauty of the interior space.

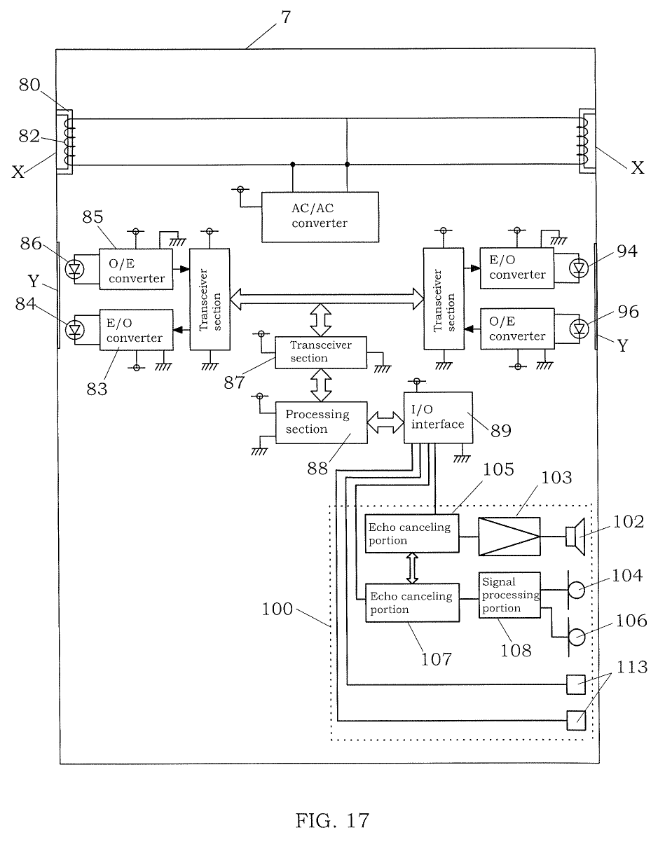

Next, the intercom unit 7 is explained, which is detachably attached to the base unit 3 and/or the function unit 4. An example of the intercom unit 7 is shown in FIG. 17. As clearly understood from this figure, the intercom unit 7 of the present embodiment has substantially the same components as the function unit 4 except for the following features. That is, the intercom unit 7 is characterized by comprising, as the function section 81 of the function unit 4, the voice information processing device 100 of the present invention, which comprises the speaker 102, the pair of microphones (104, 106) and the signal processing portion 108, an amplifying portion 103 and echo-canceling portions (105, 107) described later. The explanations about the function unit 4 other than the function section 81 can be equally adapted for the intercom unit 7, and therefore duplicate explanations are omitted.

In the intercom unit 7, according to the signal processing explained in detail in the first embodiment, the output Ma of the adder circuit 157 in the signal processing portion 108 of FIG. 6 does not substantially contain the signal component corresponding to the voice output from the speaker 102, and only the signal component corresponding to the voice provided toward the sound collecting portion of the second microphone 106 is extracted. The output Ma of the adder circuit 157 is converted from analog signal into digital signal by the A/D converting circuit 158, and then output to the echo-canceling portion 107. In the echo-canceling portion 107, the digital signal provided from the A/D converting circuit 158 is stored in a memory, and a digital signal processing described below is performed by CPU or DSP.

That is, the echo-canceling portion 107 receives the output of the echo-canceling portion 105 as a reference signal, and further performs an arithmetic operation to the output of the signal processing portion 108 such that the voice signals obtained when a receiver's voice output from the speaker 102 is picked up by the first and second microphones (104, 106) are canceled out. Therefore, even if the signal component corresponding to the voice output from the speaker remains in the output of the signal processing portion 108, the remaining signal component in the output of the second microphone 106 can be further reduced by the echo-canceling portion 107. In addition, the echo-canceling portion 105 receives the output of the echo-canceling portion 107 as a reference signal, and performs an arithmetic operation to the output of the I/O interface 89 such that voice signals obtained at another intercom unit 7 when a transmitter's voice output from a speaker is picked up by first and second microphones are canceled out. Thereby, the voice provided from the another intercom unit 7 can be clearly output from the speaker 102. Concretely, the echo-canceling portions (107, 105) are adjusted to have a loop gain of not larger than 1 by a variable attenuation means (not shown), which is formed in a loop circuit comprised of speaker 102—microphones (104, 106)—signal processing portion 108—echo-canceling portion 107—I/O interface 89—echo-canceling portion 105—amplifying portion 103—speaker 102.

According to the dual wiring system with the intercom unit 7 described above, for example, the voice signal transmitted from another intercom unit 7 installed in a different room through the information line L2 is amplified by the amplifying portion 103 through the echo-canceling portion 105, and then output from the speaker 102. In addition, by operating the operation buttons 113, the intercom unit 7 is placed in a communication enable state. The voice signals collected by the microphones (104, 106) are processed at the signal processing portion 108, then sent to the echo-canceling portion 107, and transmitted to the another intercom unit 7 installed in the different room through the information line L2. That is, it is possible to provide an intercom system having the capability of enabling a comfortable communication between rooms away from each other, while preventing the howling phenomenon.

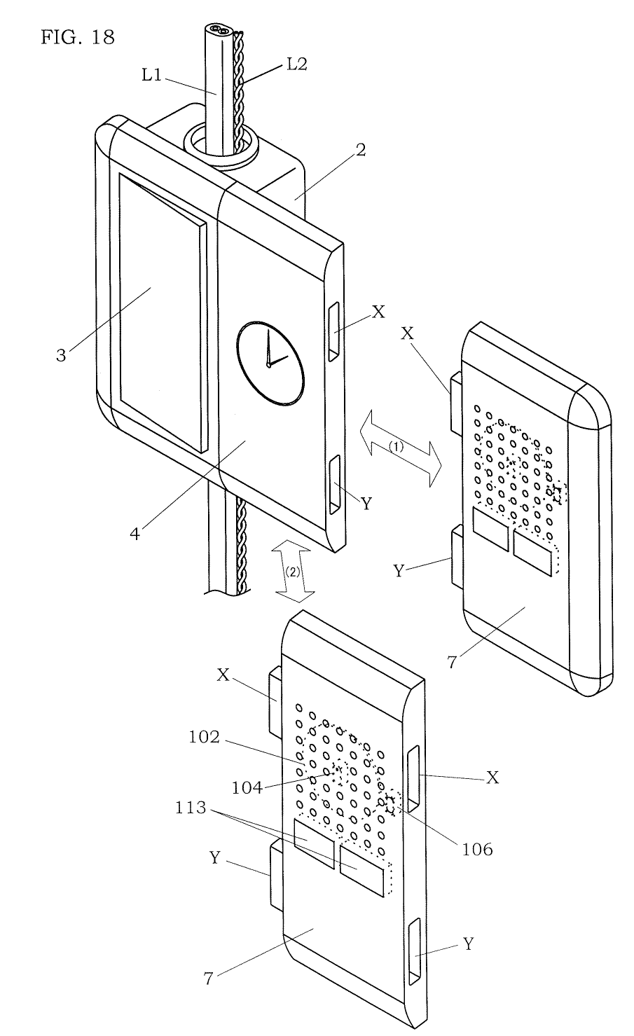

As shown by the arrow (1) in FIG. 18, the intercom unit 7 may be connected to the electromagnetic coupling portion “X” and the optical coupling portion “Y” provided at one side of the function unit 4, which is detachably connected to the base unit 3 mounted in a wall surface through the switch box 2. Alternatively, as shown by the arrow (2) in FIG. 18, the intercom unit 7 can be connected to the electromagnetic coupling portion “X” and the optical coupling portion “Y” of the base unit 3 after the function unit 4 is detached from the base unit 3. In this case, to further improve the function expandability, the electromagnetic coupling portion “X” and the optical coupling portion “Y” are formed at each of both sides of the intercom unit 7. Therefore, the base unit 3 can be connected to one side of the intercom unit 7, and the function unit 4 can be connected to the other side of the intercom unit 7. The function unit 4 shown in FIG. 18 has a timer function, which is equipped with a timer portion, a CPU portion for generating time data for the timer portion and sending it to the processing section 88 through the I/O interface 89, and a time display portion formed on the front surface of the function unit 4 to display time according to the time data.

In addition, a higher functional type intercom device 7 used in the dual wiring system is shown in FIG. 19. In this example, a function unit 4A, an additional function unit 4B and the intercom unit 7 are connected in series to the base unit 3. The base unit 3 does not have the function section. The function unit 4A detachably connected to the base unit 3 has a switch for turning on/off an air conditioning apparatus as the function section 81. The additional function unit 4B detachably connected to the function unit 4A has a controller for the air conditioning apparatus as the function section 81. The intercom unit 7 detachably connected to the additional function unit 4B functions as a main phone of the interphone system, which has the voice information processing device 100 of the present invention therein.

The function unit 4A is provided with an operation button B1, a stop button B2, and a CPU section for generating operation information of these buttons. This function unit is suitable to operate a lighting apparatus. The function unit 4B is provided with a temperature setting dial 51 for the air-conditioning equipment, an LCD (liquid crystal display) monitor 52 for displaying the setting temperature, a timer switch 53 for operating the air-conditioning equipment for a desired time period, and a CPU section for generating operation information of the temperature setting dial 51 and the timer switch 53. The intercom unit 7 is provided with a volume control button B3, the voice information processing device 100 of the present invention, a mode switch 55 for switching between transmitter and receiver functions, an LCD monitor 56 for displaying an image taken by a TV camera located at a house entrance, an unlock button B4 for unlocking the door lock, and a CPU section having the functions of voice information processing, image processing for the LCD monitor, and for generating operation information of the unlock button and the mode switch.

In this case, when a call button for visitors of the intercom unit 7 disposed at the entrance of the building structure is operated, a call signal and an image data picked up by the TV camera formed in the intercom unit for visitors are transmitted to the intercom unit 7 for dweller installed in the building structure through the information line L2, so that a ringing sound is output from the speaker 102, and the image of the visitors is displayed on the LCD monitor 56. Next, to enable the communication between the visitors and the dweller, when the dweller pushes the mode switch 55 of the intercom unit 7, the voice information of the dweller is converted into electric signals by the microphone 106, and transmitted to the intercom unit for visitors to output the voice information from the speaker. In this regard, since the voice information processing device of the present invention is installed in each of the intercom units for visitors and dweller, it is possible to achieve a comfortable interphone communication between the visitors and the dweller without causing the howling phenomenon. The functions of the function unit 4A and the additional function unit 4B are not limited to the above examples. For example, a battery charger for electric shaver, electric toothbrush, mobile phone or portable audio player may be formed as the function section.

Next, a method of mounting the base unit 3 to a wall surface, and a method of connecting the intercom unit 7 with the base unit 3 or the function unit 4 are explained.

In the present embodiment, the base unit 3 is directly fixed to the switch box 2. If necessary, as shown in FIG. 20, the base unit 3 may be fixed to the switch box 2 through an attachment plate 75. In this case, after hooks formed at both sides of the attachment plate 75 are engaged to the base unit 3, the attachment plate 75 with the base unit 3 is fixed to the switch box 2 by use of mounting screws. Alternatively, the base unit 3 may be directly mounted in the wall surface by use of exclusive clamps (not shown) without using the switch box 2.

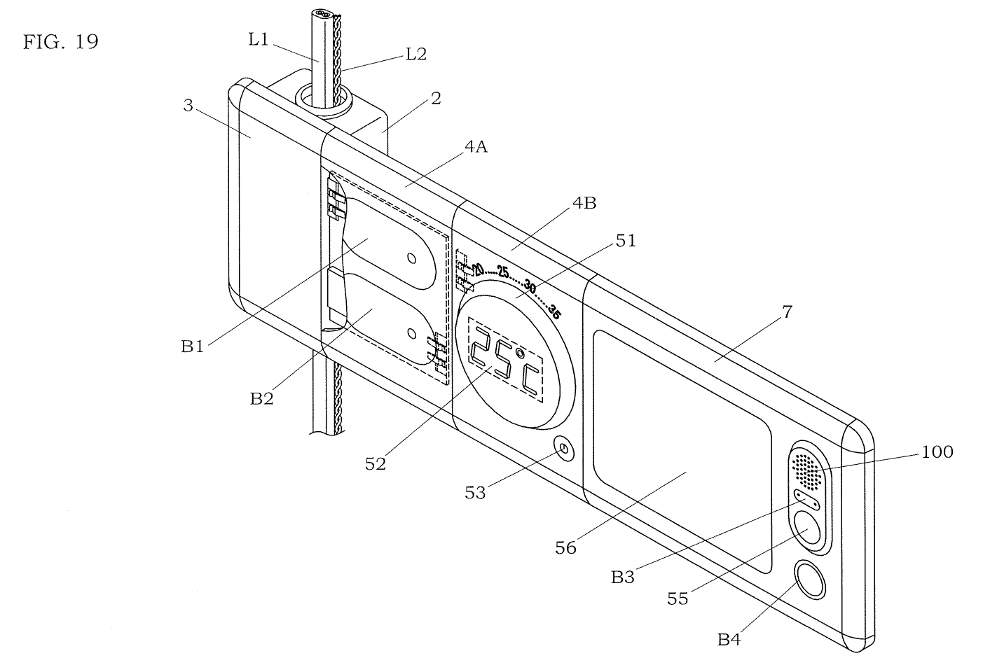

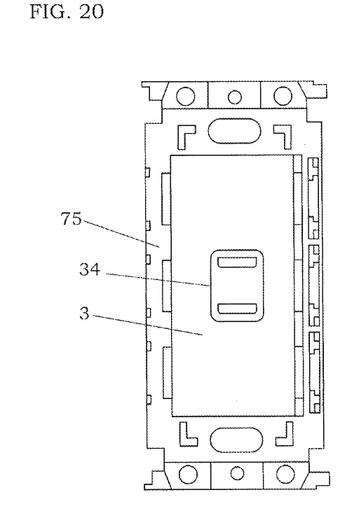

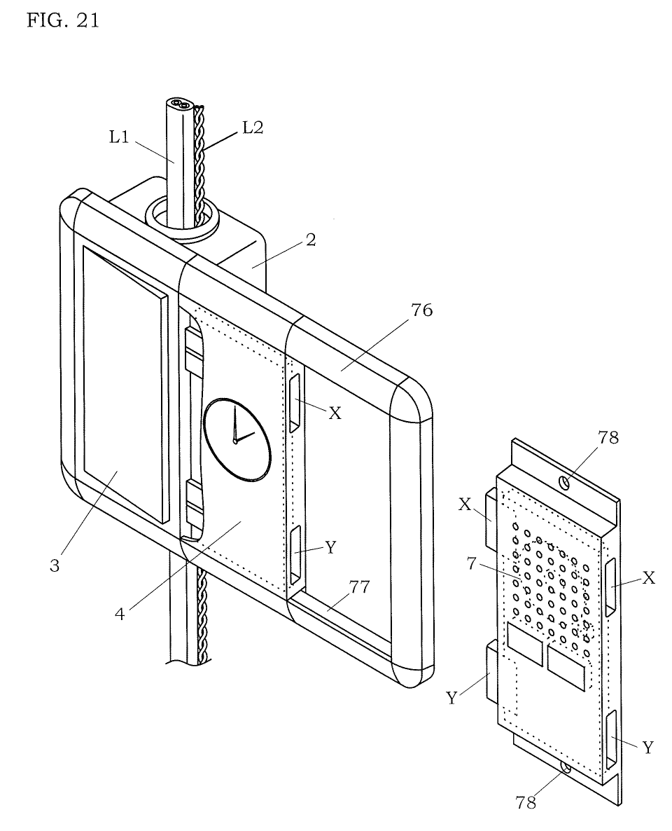

From the viewpoint of obtaining a stable connection between the intercom device 7 and the base unit 3 and/or the function unit 4, it is preferred to use a cosmetic frame 76 formed in a substantially rectangular shape and having an inner opening, as shown in FIG. 21. The cosmetic frame 76 has an attachment frame 77, to which the intercom unit 7 or the function 4 can be coupled. For example, as shown in FIG. 21, when the base unit 3 and the function unit 4 connected to the base unit 3 are previously attached to the cosmetic frame 76, the intercom unit 7 can be added by the following procedures. First, the cosmetic frame 76 is separated from the attachment frame 77. Then, the intercom unit 7 is connected to one side of the function unit 4 through the electromagnetic coupling portion X and the optical coupling portion Y. Then, the intercom unit 7 is fixed to the attachment frame 77 by tightening attachment screws (not shown) inserted in through holes formed at upper and lower end portions of the intercom unit 7. Finally, the cosmetic frame 76 is attached again to the attachment frame 77. Thus, the installing operation for the intercom unit 7 is finished. Since operating portions of the function unit 4 and the intercom unit 7 are exposed through the inner opening of the cosmetic frame 76, good operationality can be maintained. In addition, the cosmetic frame 76 is designed such that rear surfaces of the function unit 4 and the intercom unit 7 extend closely along the wall surface, it is possible to prevent the occurrence of excessive stress in the connecting portion therebetween when a physical force is applied to the operating portion of the function unit 4 or the intercom unit 7. Thus, the stable connection between the adjacent units can be achieved. Furthermore, to prevent that the beauty of the interior space is deteriorated by attaching the function unit 4 and/or the intercom unit 7 to the cosmetic frame 76, it is preferred to prepare plural kinds of cosmetic frames having different total lengths. An appropriate one of the cosmetic frames can be determined depending on the number of the intercom unit 7 and the function unit(s) 4 to be added.

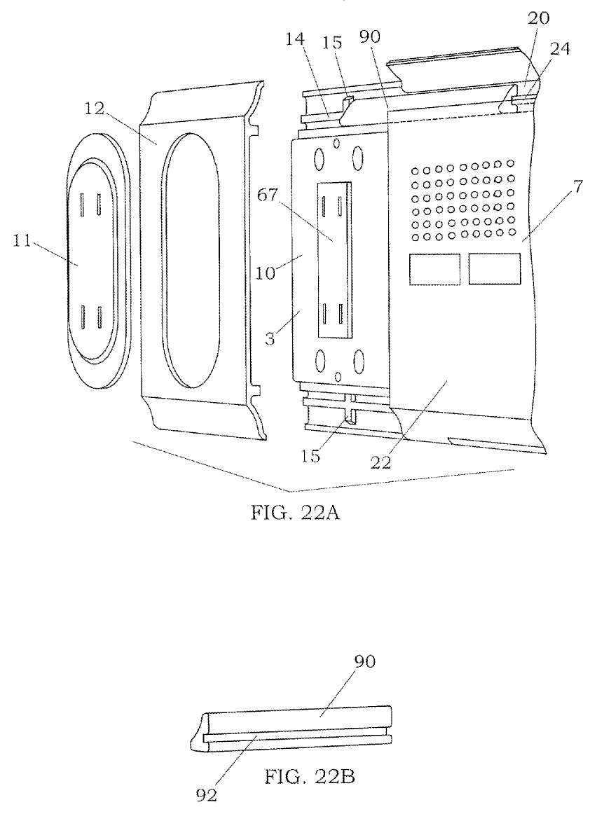

The intercom unit 7 is preferably attached to the base unit 3, as shown in FIG. 22A. That is, the cosmetic cover 12 is firstly removed from the base unit 3. In the present embodiment, since the receptacle cover 11 is separately formed from the cosmetic cover 12, the function section 67 such as the power receptacle can be protected from accidental breakage by the receptacle cover 11 during the connecting and disconnecting operation of the intercom unit 7. After the intercom unit 7 is placed at one side of the function unit 4 such that the electromagnetic coupling portion X and the optical coupling portion Y of the intercom unit 7 are disposed in face-to-face relation with them of the base unit 3, the intercom unit 7 is mechanically coupled to the base unit 3 by use of a joining member 90. Each of the base unit 3 and the intercom unit 7 comprises a housing (10, 20) having horizontal guide rails (14, 24) at its upper and lower end portions. The numeral 15 designates a stopper wall formed at a substantially center position in the longitudinal direction of the guide rail 14. On the other hand, as shown in FIG. 22B, the joining member 90 has a groove 92, in which the guide rails (14, 24) can be fitted.

As shown in FIG. 22A, on the condition that the guide rail 14 is fitted in the groove 92, the joining member 90 is slid along the guide rail 14 until contacting the stopper wall 15. As a result, the joining member 90 is engaged to the base unit 3 over about a half length of the joining member 90. On the other hand, the joining member 90 is also engaged to the intercom unit 7 in a similar manner to the above over the remaining half length of the joining member 90. Thus, after the engagements between the joining member 90 and the base unit 3 and between the joining member 90 and the intercom unit 7 are finished at both of the upper and lower end portions, cosmetic covers (12, 22) are respectively attached to the front surfaces of the base unit 3 and the intercom unit 7. Since the joining member 90 is held between the cosmetic covers (12, 22) and the housings (10, 20) of the base unit 3 and the intercom unit 7, it is possible to prevent accidental falling of the joining member 90, and obtain the stable mechanical connection therebetween without spoiling the beauty of the interior space.

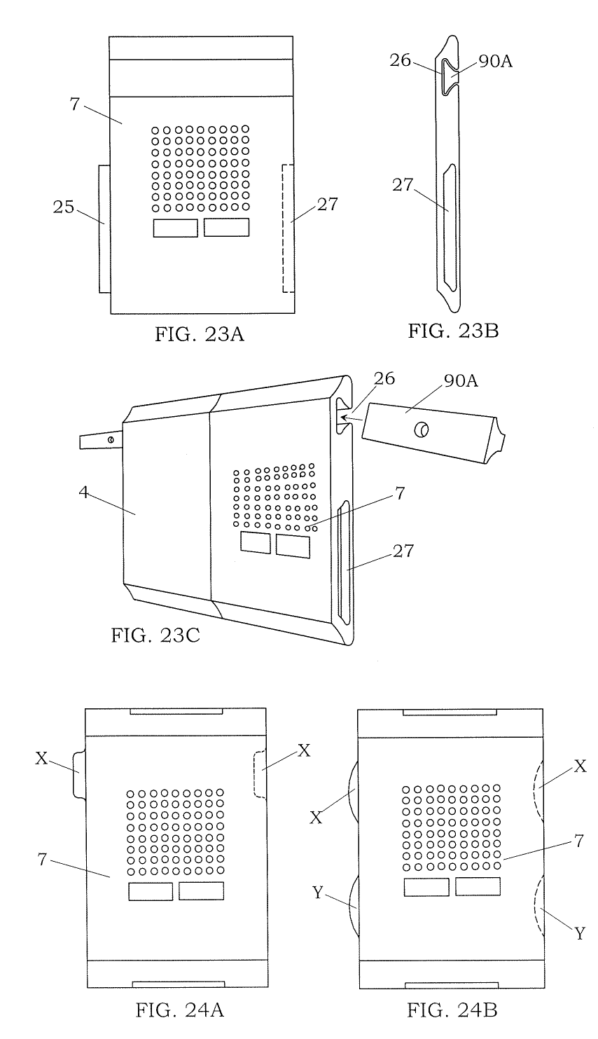

As a modification of the mechanical connection method described above, as shown in FIGS. 23A to 23C, the intercom unit 7 has a male connector 25 at its one side and a female connector 27 at the other side. Each of these connectors is formed with the electromagnetic coupling portion X and the optical coupling portion Y. In this case, the male connector 25 and the female connector 27 can be regarded as the module connector and the module port, respectively. In addition, the male connector and the female connector are formed in each of the function unit 4 and the base unit 3, so that the electric power transmission and the signal transmission become available between the intercom unit 7 and the base unit 3 and between the intercom unit 7 and the function unit 4 by means of electromagnetic coupling and optical coupling. For example, the male connector 25 of the intercom unit 7 is detachably connected to the female connector 27 of the base unit 3, and the female connector 27 of the intercom unit 7 is detachably connected to the male connector 25 of the function unit 4.

In addition, this intercom unit 7 has a horizontal groove 26, in which a joining member 90A having a similar cross section to the groove 26 can be fitted. As in the joining member 90 of FIG. 22B, one end of the joining member 90A is inserted into the groove 26 of the intercom unit 7 over about a half length of the joining member, and also the other end of the joining member 90A is inserted into a groove formed at an adjacent base unit 3 or an adjacent function unit 4 over the remaining half length of the joining member to provide the stable mechanical connection therebetween. In this case, since the groove 26 has a substantially trapezoidal cross section configured such that an opening formed in the rear surface of the intercom unit 7 corresponds to a narrow side of the trapezoidal cross section, the falling of the joining member 90A from the groove 26 can be prevented without using the cosmetic cover. In addition, since the user can access the joining member 90A through the opening of the rear surface of the intercom unit 7, the slide movement of the joining member 90A in the groove 26 can be relatively smoothly performed. On the condition that the joining member 90A does not fall through the opening of the rear surface of the intercom unit 7, the shape of the groove is not limited to the trapezoidal cross section.

As shown in FIG. 24A, only the electromagnetic coupling portion X may be formed by female and male connectors. When the male connector is provided at one side of the intercom unit 7, the female connector is provided at the other side thereof. Alternatively, as shown in FIG. 24B, each of the electromagnetic coupling portion X and the optical coupling portion Y may be provided by a female connector shaped in an arcuate concave and a male connector shaped in an arcuate convex. When using these female and male connectors, it is possible to stably obtain accurate positioning between the adjacent units, and consequently improve the reliability of the supply of electric power and the interactive communication of the information signals.

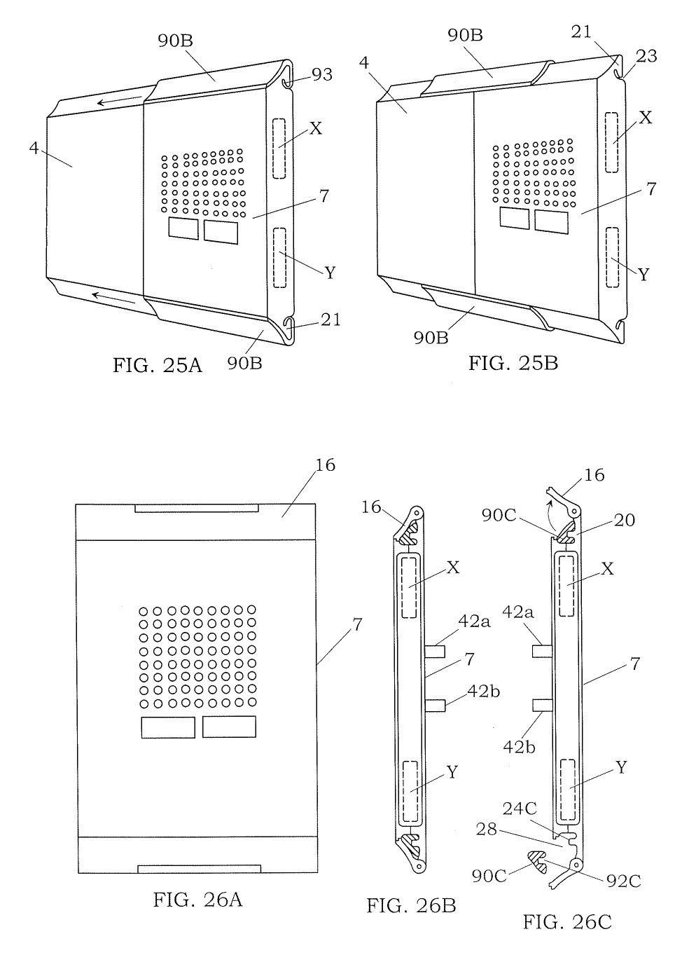

In addition, as shown in FIG. 25A, it is preferred that each of the upper and lower end portions of the intercom unit 7 has a tapered end 21 with an engaging groove 23, and a joining member 90B is formed to slidably contact the tapered end 21 and has a hook 93, which can be fitted in the engaging groove 23, at its one end. In this case, after the joining member 90B is fitted to the tapered end 21 at each of the upper and lower ends of the intercom unit 7, the joining member 90B is slid toward an adjacent function unit 4, as shown by the arrows in FIG. 25A. As a result, the stable mechanical connection between the intercom unit 7 and the function unit 4 can be achieved by use of the joining member 90B, as shown in FIG. 25B.

In addition, as shown in FIGS. 26A to 26C, it is preferred that each of the upper and lower end portions of the intercom unit 7 has a concave portion 28 for accommodating a joining member 90C, and a cover member 16 pivotally supported at its one end to the housing 20 of the intercom unit 7. The joining member 90C has a groove 92C, in which a guide rail 24C formed in the concave portion 28 can be slidably fitted. In this case, after the cover member 16 is opened to access the joining member 90C, the joining member is slid along the guide rail 24C, as in the case of FIG. 22A. Finally, the cover member 16 is closed to obtain the stable mechanical connection between the intercom unit 7 and the function unit 4. In addition, since the joining member 90C is always accommodated in the concave portion 28, there is no worry about missing the joining member 90C. As shown in FIGS. 26B and 26C, this intercom unit 7 has a module connector comprising a pair of an electric power connector 42a and an information signal connector 42b on its rear surface. These connectors are detachably connected to the gate housing 31 of the base unit 3 shown in FIG. 14.

The above-explained connection method between the intercom unit 7 and the base unit 3 or the function unit 4 is also available as the connection method between the base unit 3 and the function unit 4 or between the function units 4, In these cases, the above-described advantages can be also obtained.

As an information-signal transmitting method available in the dual wiring system of the present invention, one of baseband transmission and broadband transmission can be used. In addition, the protocol is not limited to a specific one. For example, sound and image signals may be transmitted and received according to JT-H232 packet to obtain the interactive communication between a base device and a handset of the intercom system. In a control system, it is also preferred to use a routing control protocol for a broadcast or a unicast where controlling can be performed at a control ratio of 1:1 or 1:N according to operation data. Alternatively, when the protocol used between the base units is different from the protocol used in the function unit or the intercom unit connected to the base unit, it is preferred that a protocol conversion is performed at the base unit.

In the dual wiring system explained in the present embodiment, when the intercom unit 7 is connected to the previously-installed power line L1 and information line L2 through the base unit 3 or the function unit 4, it is possible to obtain both of an electric power channel and an information channel without installing additional wirings, and therefore provide excellent construction performance. In addition, since the same information line L2 is commonly used for the function unit(s) 4 as well as the intercom unit, the intercom unit 7 can be operated in cooperation with the function unit 4. For example, when an alarm signal is transmitted from the function unit having a sensor function through the information line L2, the intercom unit 7 can be designed to output a warning sound from the speaker 102. In this case, the intercom unit 7 is used as an alarm generating portion for disaster and crime prevention systems in addition to the interphone system. Thus, by efficiently using the function of the intercom unit 7, the cost performance of the intercom unit 7 can be improved. Consequently, it is possible to provide a multifunctional wiring system, which is excellent in function expandability and easy exchangeability, as compared with a conventional isolated-type intercom device, which is semipermanently fixed to a wall surface.

### Third Embodiment

The wiring system of the present embodiment is a power line communication type wiring system for transmitting information signals by use of a power line installed in a building structure, which is different from the dual wiring system of the second embodiment by comprising a transmitting and receiving means configured to enable transmitting and receiving the information signals by power line communication. The configuration of the voice information processing portion of the first embodiment is also available in this embodiment, as in the second embodiment.

That is, in the wiring system of the present embodiment, only the electric power line L1 is previously connected to each of the switch boxes 2. Therefore, the base unit 3 is connected only to the electric power line. When the function unit 4 is connected to the power line through the base unit 3, it has at least one of functions of supplying electric power from the electric power line, outputting information carried by use of the electric power line, and inputting information to be carried into the electric power line.

As described above, since the information signal is carried by use of the electric power line, the transmitting and receiving means having the power line communication function is needed in the present embodiment. This transmitting and receiving means can be formed in any one of the base unit 3, the function unit 4 and the intercom unit 7. For example, when the transmitting and receiving means is formed in the base unit 3, information transmission can be separated from power transmission by the base unit 3. Therefore, the function unit 4 and the intercom unit 7 of the second embodiment can be used in the present embodiment.

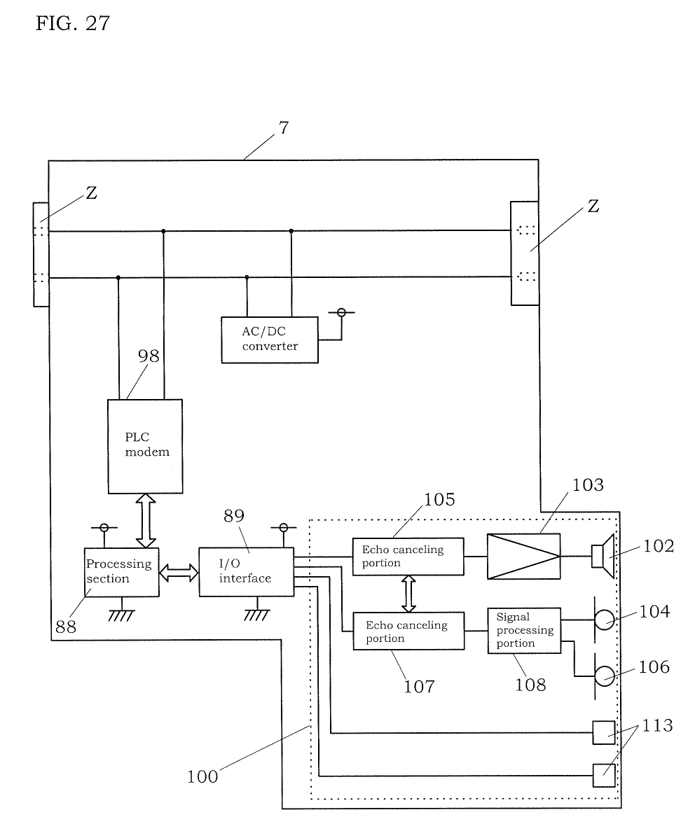

In this embodiment, it is explained about a case where the intercom unit 7 has the transmitting and receiving means. That is, the intercom unit 7 is detachably connected to the base unit 3 or the function unit 4 by use of a power transmission connector Z. Therefore, this power transmission connector Z functions as both of a power transmission means and a signal transmission means with the base unit 3 or the function unit 4. As shown in FIG. 27, the intercom unit 7 comprises a PLC modem 98 for receiving and transmitting the information signals through the power line communication, a processing section 88 for performing data processing of the information signals received through the PLC modem 98, and generating data of the information signals to be transmitted by the power line communication through the PLC modem, the voice information processing device 100 of the present invention as the function section, and an I/O interface 89 formed between the processing section 88 and the function section. According to the intercom unit 7 in the wiring system of the present embodiment, the voice information received by the PLC modem 98 is output from the speaker 102, and the voice information input from the second microphone 106 is transmitted through the PLC modem 98 by the power line communication. The same configuration as the PLC modem 98 may be formed in the base unit 3 and the function unit 4.

As a modulating method for the power line communication used in the present embodiment, a wideband spread spectrum communication method, a multicarrier method, an OFDM method or the like may be used. In the wiring system of the present embodiment, since the information is transmitted by the power line communication, it is enough to install only the electric power line in the building structure. Therefore, it is possible to improve easiness of construction works, and achieve a reduction in construction cost. In addition, when the PLC modem is built in a lighting apparatus or an air conditioning apparatus, the information signals can be directly transmitted to those electric appliances. Therefore, there is a further advantage that it is not needed to separately prepare the function unit having an infra-red remote control signal emitting function.

### Fourth Embodiment

The voice information processing device 100 of this embodiment is characterized in that the first microphone 104 is disposed at a rear side of the diaphragm 120 of the speaker 102. The signal processing portion 108 of this embodiment is substantially the same as that of the first embodiment. Therefore, the duplicate explanations are omitted.

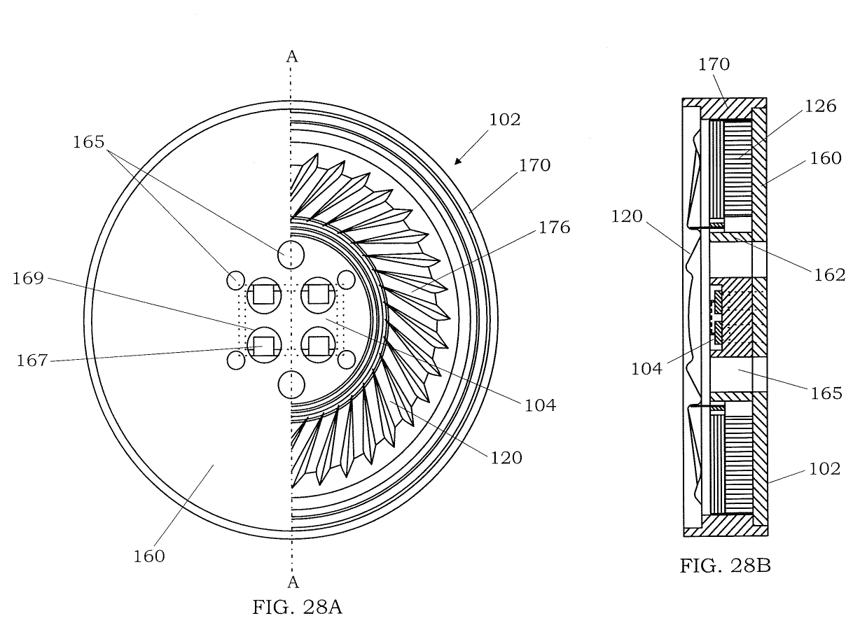

That is, as shown in FIGS. 28A and 28B, the speaker 102 used in the present embodiment comprises a ring-like permanent magnet 126 (e.g., remnant flux density 1.39T˜1.43T) made of neodymium, and a circular magnetic body 160 arranged in a concentric manner on one end surface of the permanent magnet 126. The magnetic body 160 has a rib 162 facing an inner peripheral surface of the permanent magnet 126. A voice coil 125 formed by winding a polyurethane copper wire (e.g., φ0.05 mm) around a kraft paper tube is disposed in a clearance between the inner peripheral surface of the permanent magnet 126 and the rib 162. The magnetic body 160 is preferably formed by use of an iron-based material having a thickness of about 0.8 mm such as cold-reduced carbon steel sheets (SPCC, SPCEN) and an electromagnetic soft iron (SUY).

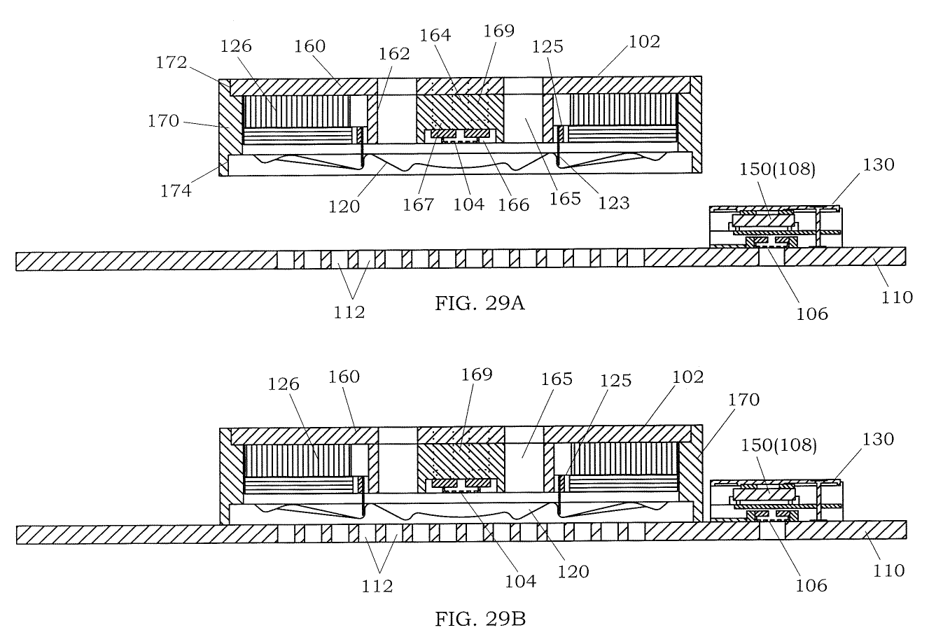

As shown in FIGS. 29A and 29B, the permanent magnet 126 and the magnetic body 160 are accommodated in a cylindrical case of a synthetic resin such as an acetal resin. An outer peripheral surface of the permanent magnet 126 contacts an inner side surface of the case 170, and the outer peripheral surface of the magnetic body 160 is fitted to a recess 172 formed in one end of the inner side surface of the case 170. When the case 170 is formed by use of a non-magnetic material such as the synthetic resin, it is possible to reduce leakage flux from the outer peripheral surfaces of the permanent magnet 126 and the magnetic body 160. An outer peripheral edge portion of the dome-shaped diaphragm 120 is secured to a recess 174 formed in the other end of the inner side surface of the case 170.

The diaphragm 120 is formed by use of a thermoplastic resin material (e.g., thickness 12 μm˜35 μm) such as PET (PolyEthyleneTerephthalate) and PEI (Polyetherimide). A tubular bobbin 123 is fixed to a rear surface of the diaphragm 120. The voice coil 125 is formed on a rear end of the bobbin 123 at an end portion of the rib 162. The bobbin 123 and the voice coil 125 are arranged to be movable in an axial direction (the up and down direction in the figure) at the vicinity of the end portion of the rib 162. In FIG. 28A, the numeral 176 designates a tangential shaped rib formed to improve the rigidity of the diaphragm 120. In the present embodiment, the first microphone 104 is disposed to face a substantially center of a rear surface of the diaphragm 120 in the ring-like rib 162 used as a tubular partition wall. A columnar portion 164 is formed so as to project from a center of the circular magnetic body 160 toward the diaphragm 120. A top end of the columnar portion 164 has a concave portion 166.

The first microphone 104 is accommodated in the concave portion 166 such that its sound collecting portion faces the rear surface of the diaphragm 120. In addition, the first microphone 104 has a pad 167 connected to a lower electrode 141 or an upper electrode 142 through a terminal 149 of FIG. 3B. In a bottom surface of the concave portion 166 for accommodating the first microphone 104, an opening 169 is formed in the axial direction. Wirings for the first microphone 104 are formed through this opening. On the other hand, the second microphone 106 is disposed at a position not facing the diaphragm 120 and laterally spaced away from the speaker 102 such that its sound collecting portion faces toward the forward direction (the front surface of the speaker also faces toward the same forward direction). The other configurations of the second microphone are the same as those of the first embodiment, and therefore duplicate explanations are omitted.

When a voice signal is input in the polyurethane copper wire of the voice coil 125, an electromagnetic force occurs in the voice coil 125 due to the electric current of this voice signal and the magnetic field of the permanent magnet 126. This electromagnetic force vibrates the bobbin 123 with the diaphragm 120. As a result, a voice corresponding to the voice signal is output from the diaphragm 120. As an example, the speaker has a diameter of 20 to 25 mm, and a thickness of about 4.5 mm.

To give a strong excitation force to the diaphragm 120, it is preferred that the bobbin 123 is connected at a position as far as possible away from the outer edge portion as a supporting point of the diaphragm 120, i.e., at the vicinity of a center of the diaphragm 120. In the present embodiment, since the voice coil 125 is disposed inside of the permanent magnet 126, and the bobbin 123 is connected at the vicinity of the center of the diaphragm 120, it is possible to efficiently give the excitation force to the diaphragm 120.

The speaker 102 of the present embodiment has ventilation holes 165 each penetrating in the axial direction at the inner peripheral side of the rib 162 of the circular magnetic body 160. The ventilation holes 165 are arranged around the center of the circular magnetic body 160 along a circular pattern. In this case, since the interior of the speaker 102 is ventilated through these ventilation holes 165, it is possible to reduce stress occurring in the speaker 102 due to air pressure variations during the vibration of the diaphragm 120.

As described above, since the first microphone 104 is disposed to face the rear surface of the diaphragm 120 of the speaker 102, there is an advantage that a reduction in size and thickness of the entire device can be achieved.

### Fifth Embodiment

The voice information processing device of this embodiment is substantially the same as that of the first embodiment except for using a different structure of the speaker 102. Therefore, duplicate explanations are omitted with respect to the other configurations.

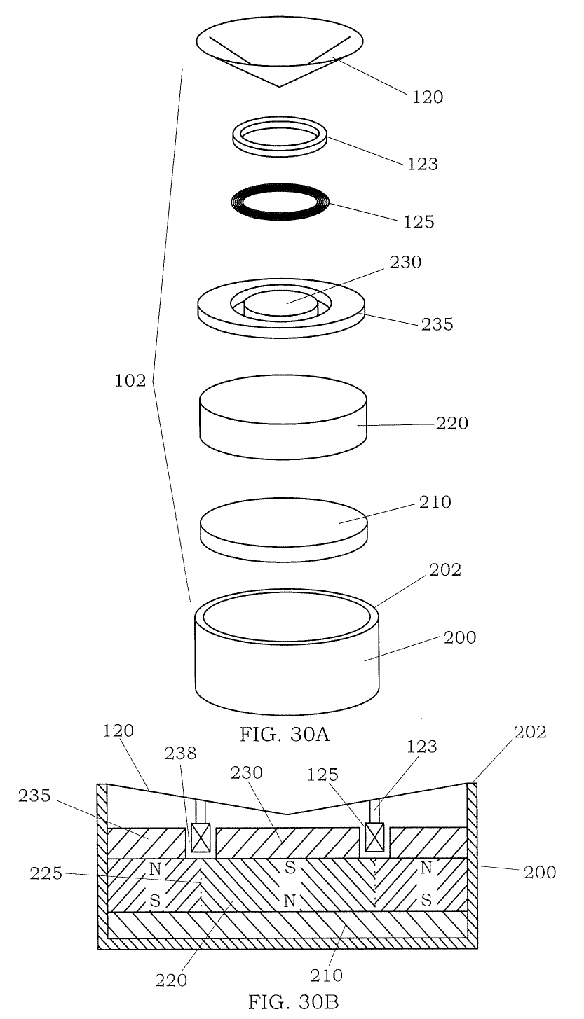

As shown in FIGS. 30A and 30B, the speaker 102 of the present embodiment is composed of a cylindrical case 200 having an opening at its one end, and a bottom at the other end, a disk-like magnetic body 210 such as iron disposed on the bottom of the case 200, a columnar magnet 220 disposed on the disk-like magnetic body 210, a set of a columnar magnetic body 230 and a ring-like magnetic body 235, which are preferably made of iron and disposed on the columnar magnet 220, a voice coil 125, a bobbin 123, and a dome-shaped diaphragm 120. These members are concentrically disposed in a stacking manner. An outer edge portion of the diaphragm 120 is supported by a peripheral edge portion 202 around the opening of the case 200. The case 200 is preferably made of a synthetic resin such as an acetal resin to reduce leakage flux from the magnets and magnetic bodies disposed therein.

The columnar magnet 220 is magnetized such that a center portion and an outer peripheral portion have opposite magnetic poles. In addition, as shown in FIG. 30B, an upper side of the center portion is S pole, a lower side of the center portion is N pole, an upper side of the outer peripheral portion is N pole, and a lower side of the outer peripheral portion is S pole. The magnetic poles of the center portion and the outer peripheral portion of the columnar magnet 220 may be reversed. In addition, a boundary region between the center portion and the outer peripheral portion is defined as a magnetic pole changing region 225.

The columnar magnetic body 230 is disposed on the center portion of the columnar magnet 220, and the ring-like magnetic body 235 is disposed on the outer peripheral portion of the columnar magnet 220. A gap 238 is formed in a concentric manner with respect to the columnar magnet 220 and between the outer peripheral surface of the columnar magnetic body 230 and the inner peripheral surface of the ring-like magnetic body 235. The gap 238 corresponds to the magnetic pole changing region 225. That is, the magnetic pole changing region 225 is exposed through the gap 238.

The voice coil 125 is disposed in the gap 238 to be movable in the up and down direction of FIG. 30B. The voice coil 125 is connected to a rear surface of the diaphragm 120 through the ring-like bobbin 123. When a voice signal is input in the voice coil 125, an electromagnetic force occurs in the voice coil 125 due to an electric current flowing in this voice coil 125 and a magnetic field of the columnar magnet 220, so that the bobbin 123 vibrates together with the diaphragm 120 in the up and down direction of FIG. 30B. Thereby, a voice corresponding to the voice signal is output from the diaphragm 120.

As described above, when the center portion and the outer peripheral portion, which have the opposite magnetic poles, are integrally formed by a single columnar magnet 220, an improvement in fabrication easiness is achieved, as compared with the case where they are separately formed. In addition, since the single magnet is fitted into the case 200, magnetic energy can be increased by an increase in magnetic fluxes interlinked with the voice coil 125. As a result, it is possible to provide the speaker having high output efficiency. In addition, for the purpose of providing a same output, the speaker can be downsized, as compared with the conventional case.

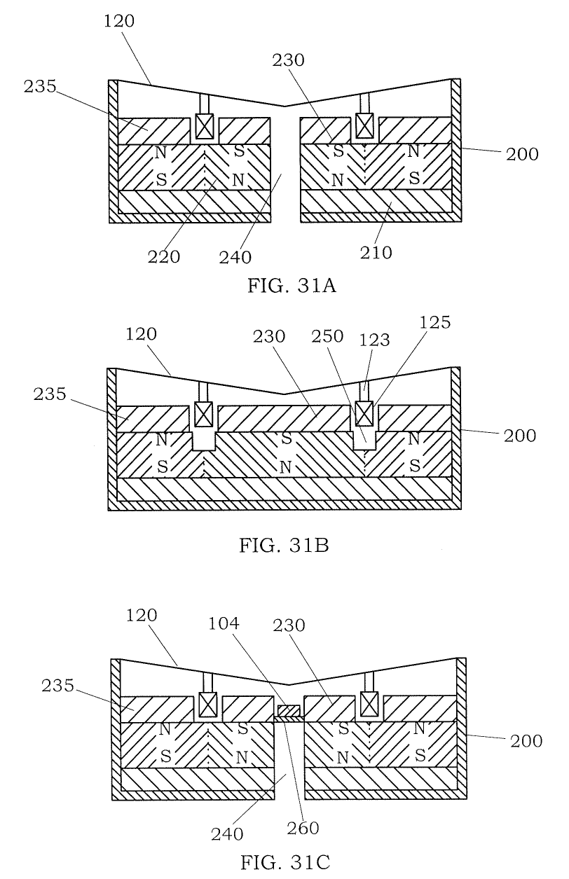

As shown in FIG. 31A, a communication hole 240 penetrating through the columnar magnet 220, the columnar magnetic body 230, the disk-like magnetic body 210 and the case 200 in the axial direction may be formed at a position facing a substantially center of the diaphragm 120. In this case, an airflow caused by vibrations of the diaphragm 120 can be exhausted to the outside through the communication hole 240. As a result, it is possible to reduce the stress occurring in the diaphragm 120 due to air pressure variations during the vibration of the diaphragm 120.

As shown in FIG. 31B, it is also preferred that a concave portion 250 is formed in the magnetic pole changing region 225 of the columnar magnet 220. In this case, it is possible to prevent that the voice coil interferes with the columnar magnet 220 at the time of displacement of the voice coil 125. The same effect can be obtained when the concave portion is formed in the speaker of FIG. 31A.

Furthermore, when the first microphone 104 is disposed at the rear side of the diaphragm 120 of the speaker, it is preferred that a microphone accommodating portion 260 is formed in the communication hole 240, and the first microphone 104 is disposed in the microphone accommodating portion such that the sound collecting portion faces the rear surface of the diaphragm, as shown in FIG. 31C.

### Sixth Embodiment

The voice information processing device of this embodiment is substantially the same as that of the first embodiment except for using a different speaker structure. Therefore, duplicate explanations are omitted with respect to the other configurations.

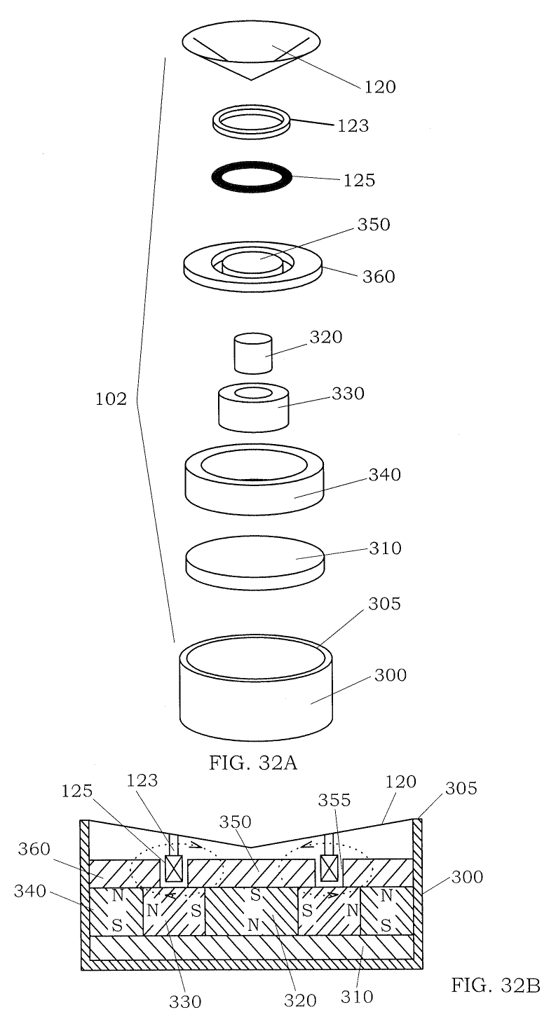

As shown in FIGS. 32A and 32B, the speaker 102 of the present embodiment is composed of a cylindrical case 300 having an opening at its one end, and a bottom at the other end, a columnar magnetic body 310 such as iron disposed on the bottom of the case 300, a columnar magnet 320 disposed at the vicinity of a center of the columnar magnetic body 310, an inner cylindrical magnet 330 disposed such that its inner peripheral surface contacts an outer peripheral surface of the columnar magnet 320, an outer cylindrical magnet 340 disposed such that its inner peripheral surface contacts an outer peripheral surface of the inner cylindrical magnet 330, a columnar magnetic body 350 preferably made of iron and disposed on the columnar magnet 320, a ring-like magnetic body 360 disposed on the outer cylindrical magnet 340, a voice coil 125, a bobbin 123, and a dome-shaped diaphragm 120. These are concentrically disposed in a stacking manner. An outer edge portion of the diaphragm 120 is supported by a peripheral edge portion 305 around the opening of the case 300. The case 300 is preferably made of a synthetic resin such as an acetal resin to reduce leakage flux from the magnets and magnetic bodies disposed therein.

In FIG. 32B, the columnar magnet 320 is magnetized such that an upper portion is S pole, and a lower portion is N pole. The inner cylindrical magnet 330 is magnetized such that an inside portion is S pole, and an outside portion is N pole. The outer cylindrical magnet 340 is magnetized such that an upper portion is N pole, and a lower portion is S pole. The magnet poles of the columnar magnet 320, the inner cylindrical magnet 330 and the outer cylindrical magnet 340 may be reversed.

A ring-like gap 355 is formed between the outer peripheral surface of the columnar magnetic body 350 and the inner peripheral surface of the ring-like magnetic body 360 such that an end surface of the inner cylindrical magnet 330 is exposed through the gap 355. The voice coil 125 is disposed in this gap 355 to be movable in the up and down direction of FIG. 32B. The voice coil 125 is connected to a rear surface of the diaphragm 120 through the bobbin 123 having a circular-ring shape. When a voice signal is input in the voice coil 125, an electromagnetic force occurs in the voice coil 125 due to an electric current flowing in this voice coil 125 and magnetic fields of the columnar magnet 320, the inner cylindrical magnet 330 and the outer cylindrical magnet 340. This electromagnetic force vibrates the bobbin 123 with the diaphragm 120 in the up and down direction. As a result, a voice corresponding to the voice signal is output from the diaphragm 120.

In the speaker of the present embodiment, since the inner cylindrical magnet 330 magnetized in the radial direction is disposed between the columnar magnet 320 and the outer cylindrical magnet 340, a magnetic flux channel is developed around the voice coil 125, as shown by dotted arrows in FIG. 32B. In this case, magnetic energy is increased by an increase in magnetic fluxes interlinked with the voice coil 125. As a result, the same effect as the sixth embodiment can be obtained. As an example, when the electromagnetic force developed in the gap 355 by inputting 0.4 W in the voice coil 125 is simulated, it becomes higher by 5 to 10% than that obtained in the conventional speaker.

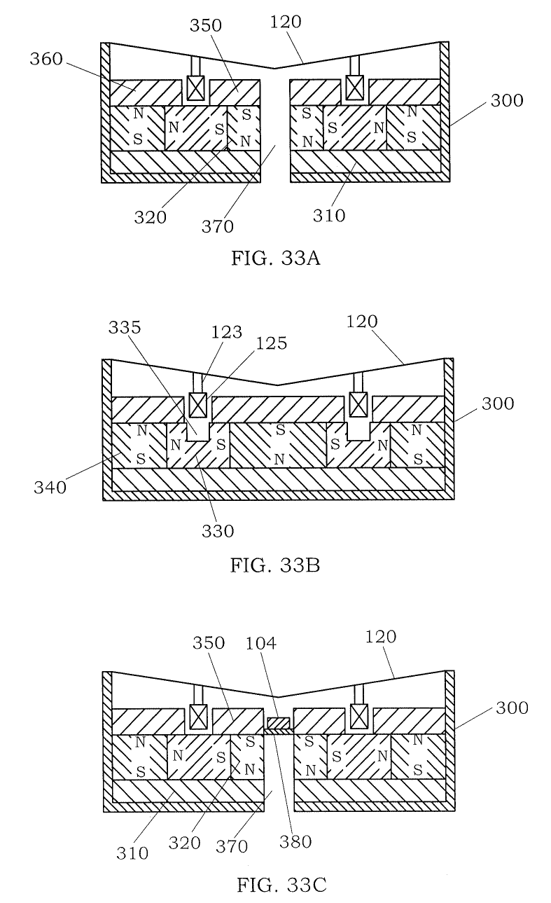

As shown in FIG. 33A, a communication hole 370 penetrating through the columnar magnet 350, the columnar magnet 320, the columnar magnetic body 310, and the case 300 in the axial direction may be formed at a position facing a substantially center of the diaphragm 120. In this case, an airflow caused during the vibration of the diaphragm 120 can be exhausted to the outside through the communication hole 370. As a result, it is possible to reduce stress occurring in the diaphragm 120 due to air pressure variations during the vibration of the diaphragm 120.

As shown in FIG. 33B, it is also preferred that a ring-like concave portion 335 is formed on the inner cylindrical magnet 330. In this case, it is possible to prevent that the voice coil 125 interferes with the inner cylindrical magnet 330 at the time of displacement of the voice coil 125. The same effect can be obtained when the concave portion 335 is formed in the speaker of FIG. 33A.

Furthermore, when the first microphone 104 is disposed at the rear side of the diaphragm 120 of the speaker, it is preferred that a microphone accommodating portion 380 is formed in the communication hole 370, and the first microphone 104 is disposed in the microphone accommodating portion such that the sound collecting portion faces the rear surface of the diaphragm, as shown in FIG. 33C.

### Seventh Embodiment

The voice information processing device of this embodiment is substantially the same as that of the first embodiment except for using a different speaker structure. Therefore, duplicate explanations are omitted with respect to the other configurations.

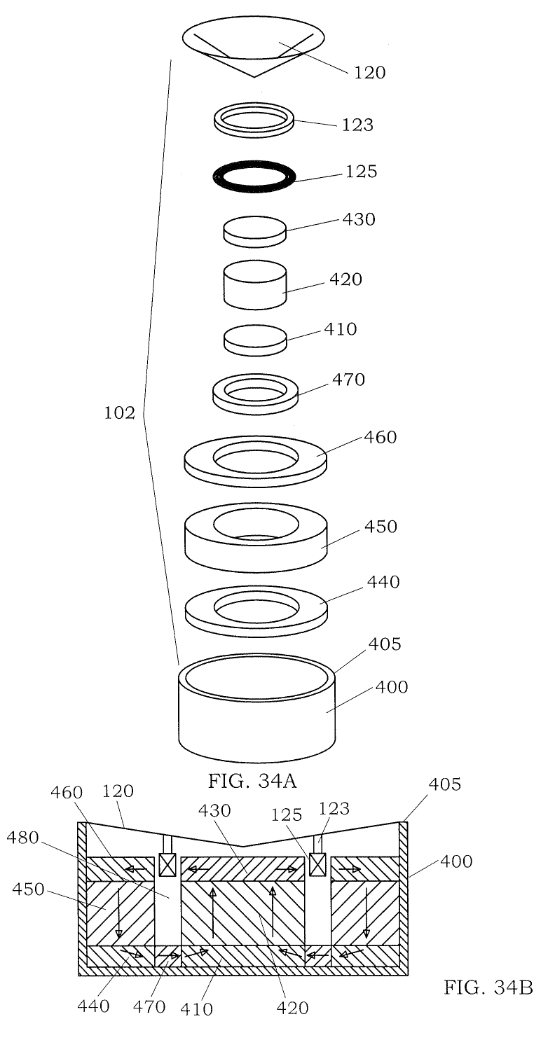

As shown in FIGS. 34A and 34B, the speaker 102 of the present embodiment is composed of a cylindrical case 400 having an opening at its one end, and a bottom at the other end, first, second and third columnar magnets (410, 420, 430) stacked on a center region of the bottom of the case 400 in a height direction, first, second and third cylindrical magnets (440, 450, 460) stacked on an outer peripheral portion of the bottom of the case 400 in the height direction, an intermediate cylindrical magnet 470 disposed on the bottom of the case 400 between the first columnar magnet 410 and the first cylindrical magnet 440, a voice coil 125, a bobbin 123, and a dome-shaped diaphragm 120. These are concentrically disposed in a stacking manner. An outer edge portion of the diaphragm 120 is supported by a peripheral edge portion 405 around the opening of the case 400. The case 400 is preferably made of a nonmagnetic material, e.g., a synthetic resin such as an acetal resin to reduce leakage flux from the magnets and magnetic bodies disposed therein.

In a groove 480 provided between outer peripheral surfaces of the second and third columnar magnets (420, 430) and inner peripheral surfaces of the second and third cylindrical magnets (450, 460), the voice coil 125 is disposed to be movable in the up and down direction of FIG. 34B. The voice coil 125 is connected to a rear surface of the diaphragm 120 through the bobbin 123 of a circular-ring shape.

Next, it is explained about a magnetizing direction of each of the magnets. Arrows shown in FIG. 34B designates the magnetizing directions. Top and bottom ends of each of the arrows correspond to N and S poles, respectively. In brief, the magnets disposed in the case 400 are magnetized such that magnetic fluxes generated by these magnets extend in a loop manner around the groove 480. If necessary, the magnetic poles of these magnets may be reversed.

When a voice signal is input in the voice coil 125 of the speaker 102 described above, an electromagnetic force occurs in the voice coil 125 due to an electric current flowing in this voice coil 125 and magnetic fields of the magnets (410, 420, 430, 440, 450, 460, 470). This electromagnetic force vibrates the bobbin 123 with the diaphragm 120 in the up and down direction of FIG. 34B. As a result, a voice corresponding to the voice signal is output from the diaphragm 120.

In the speaker of the present embodiment, as in the fifth and sixth embodiments, it is possible to increase the number of magnetic fluxes interlinked with the voice coil 125, and obtain a high output efficiency due to an increase in electromagnetic attraction force acting on the voice coil 125. Moreover, for the purpose of providing a same output, the speaker can be downsized, as compared with the conventional case.

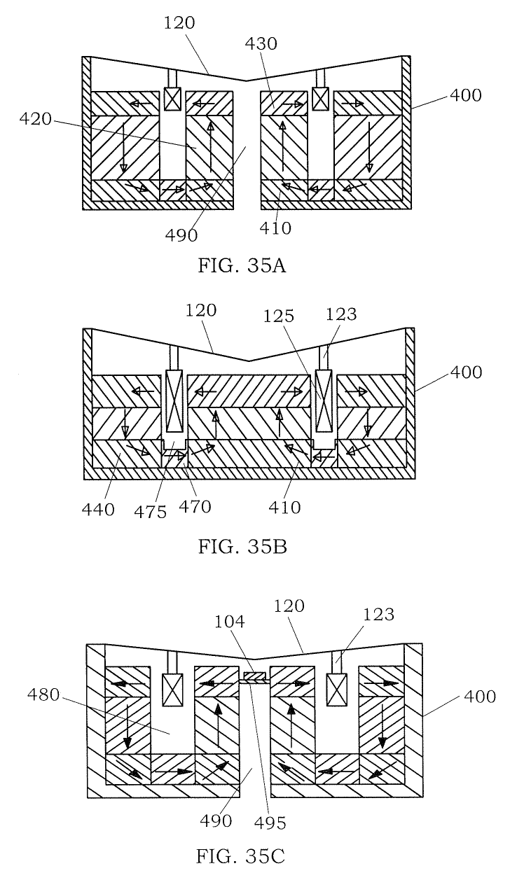

As shown in FIG. 35A, a communication hole 490 penetrating through the first, second and third columnar magnets (410, 420, 430) and the case 400 in the axial direction may be formed at a position facing a substantially center of the diaphragm 120. In this case, an airflow caused by the vibration of the diaphragm 120 can be exhausted to the outside through the communication hole 490. As a result, it is possible to reduce stress occurring in the diaphragm 120 due to air pressure variations during the vibration of the diaphragm 120.

As shown in FIG. 35B, it is also preferred that a ring-like concave portion 475 is formed on the intermediate cylindrical magnet 470. In this case, it is possible to prevent that the voice coil 125 interferes with the intermediate cylindrical magnet 470 at the time of displacement of the voice coil 125. The same effect can be obtained when the concave portion 475 is formed in the speaker of FIG. 35A.

Furthermore, when the first microphone 104 is disposed at the rear side of the diaphragm 120 of the speaker, it is preferred that a microphone accommodating portion 495 is formed in the communication hole 490, and the first microphone 104 is disposed in the microphone accommodating portion such that the sound collecting portion faces the rear surface of the diaphragm 120, as shown in FIG. 35C.

### Eighth Embodiment

The voice information processing device of this embodiment is substantially the same as that of the first embodiment except for using a different microphone structure. Therefore, duplicate explanations are omitted with respect to the other configurations.

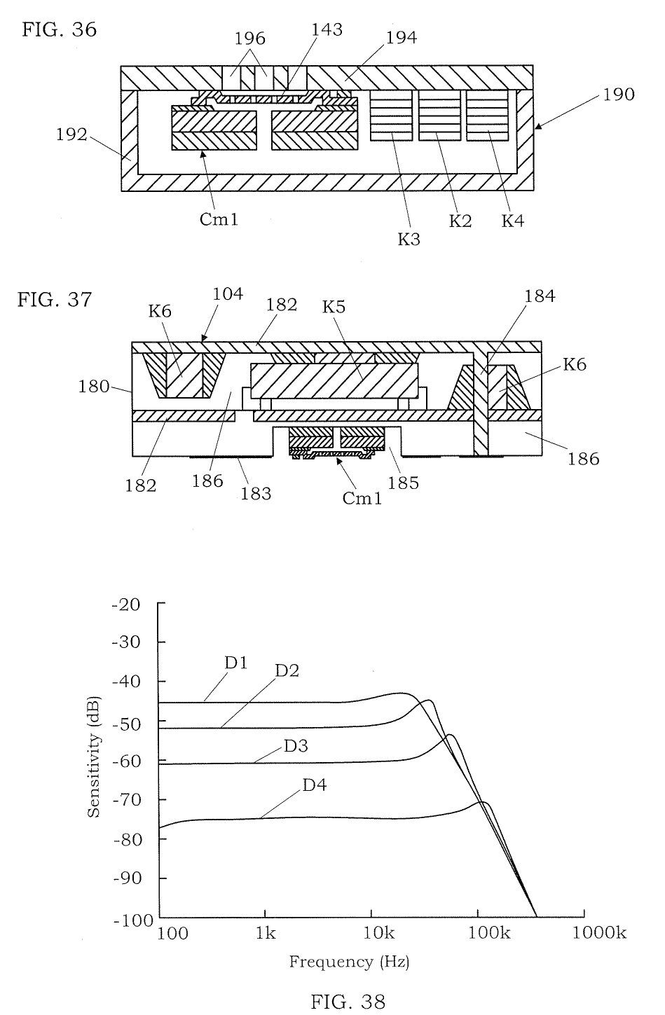

The microphone of this embodiment can be used as the first and second microphones (104, 106) of the first embodiment. As shown in FIG. 36, an acoustic signal-electric signal converting portion Cm1 (or Cm2), a bias driving circuit K2, an impedance conversion circuit K3, and an A/D conversion circuit K4 are accommodated in a housing 190. The housing 190 is formed with a case 192 having an opening, and a cover 194 for closing the opening of the case 192. Sound passing holes 196 are formed in a surface of the housing 190 facing a vibrating portion 143 (a sound collecting portion) of the acoustic signal-electric signal converting portion Cm1. To obtain an electromagnetic shielding function, the housing 190 is preferably provided by a metal housing, or a ceramic housing having a shield pattern thereon. Alternatively, the housing 190 may be grounded. Thus, when the acoustic signal-electric signal converting portion Cm1 (or Cm2) and the circuit parts (K2, K3, K4) are accommodated in the housing 190 having the electromagnetic shielding function, it is possible to output the voice signal, while suppressing noises.

The structure of the acoustic signal-electric signal converting portion is not limited to a specific one. As described in the first embodiment, for example, when using a capacitor-type silicon microphone, which is formed by use of a semiconductor material having a thickness of 2.5 mm and 2 mm on a side, the microphone can be downsized and thinned, as compared with the case of a conventional electret capacitor microphone. In addition, the number of the acoustic signal-electric signal converting portion is not limited to one. For example, four acoustic signal-electric signal converting portions may be disposed in the housing 190. Moreover, when the bias driving circuit K2, the impedance conversion circuit K3, and the A/D conversion circuit K4 are formed by a single semiconductor integrated circuit, the microphone can be further downsized and thinned. Alternatively, two circuits selected from the bias driving circuit K2, the impedance conversion circuit K3, and the A/D conversion circuit K4 may be formed by a single semiconductor integrated circuit to obtain the same effect.

As a modification of the present embodiment, as shown in FIG. 37, a microphone formed by a module incorporating circuit parts may be used as the first and second microphones (104, 106) of the first embodiment. This microphone has a structure obtained by pressure bonding a circuit accommodation layer 180 between substrates 182 used for outer wiring patterns.

The circuit accommodation layer 180 can be formed by embedding a semiconductor integrated circuit K5 including the bias driving circuit, the impedance conversion circuit, and the A/D conversion circuit, circumferential parts K6, and a plurality of vias (inner vias) 184 provided by rectangular posts of copper in an organic green sheet (OGS) 186, which comprises a base of a PET film and a filler containing epoxy resin layer on the base. In addition, the semiconductor integrated circuit K5 has electrode portions exposed on its front and rear surfaces. By using the vias 184, it is possible to omit the step of forming through-hole wirings in the organic green sheet 186. In each of the substrates 182, a copper wiring pattern is formed on front and rear surfaces of an insulating substrate such as an FR-4 core material having a thickness of 100 μm. The substrates 182 are electrically connected to the electrode portions exposed on the front and rear surfaces of the semiconductor integrated circuit K5.

In addition, another organic green sheet 186 is bonded to a surface of the substrate 182, which does not contact the circuit accommodation layer 180. A ground layer 183 is formed on this organic green sheet 186. In addition, this organic green sheet 186 has a concave portion 185, in which the acoustic signal-electric signal converting portion Cm1 (or Cm2) is disposed. Thus, when the microphone is formed by the above-described module incorporating circuit parts therein, it becomes possible to achieve a further reduction in size and thickness of the microphone.

By the way, the first microphone 104 explained in the above embodiments is used to detect an acoustic signal in an audible region. Alternatively, the first microphone may have the capability of detecting the acoustic signal in an ultrasonic region as well as the audible region. In this case, it can be used as a signal receiving means for an ultrasonic remote controller.

When the vibrating portion 143 (e.g., FIG. 3B) of the acoustic signal-electric signal converting portion Cm1 of the first microphone 104 is formed in a circular shape having a uniform thickness “b”, and the vibrating portion 143 has a radius “a”, a fundamental resonance frequency “fo” in a case where the vibrating portion 143 vibrates in the normal direction is represented by the following equation:

fo=0.467×√{E/ρ(1−ρ²)}/a²

wherein “E” is Young's modulus of the vibrating portion 143, and “ρ” is Poisson's ratio.

With respect to sensitivity characteristics of the capacitor-type microphone, it is usually needed to obtain a uniform or flat sensitivity over a frequency band lower than this fundamental resonance frequency “fo”. For example, when the first microphone 104 detects the acoustic signal in the audible region, it is enough to obtain the flat sensitivity in the audible band of 50 Hz to 16 KHz. On the other hand, when the first microphone 104 detects the acoustic signal in the ultrasonic region, it is needed to reduce the radius “a” of the vibrating portion 143 to obtain the flat sensitivity in the higher frequency region. For example, FIG. 38 shows a change in relative sensitivity estimated by use of a simplified simulation model when each of “a1” (a representative dimension), “a1×⅘”, “a1×⅗” and “a1×⅖”, is used as the radius “a” of the vibrating portion 143. In FIG. 38, the characteristic D1 corresponds to the case where the radius “a” is “a1”, the characteristic D2 corresponds to the case where the radius “a” is “a1×⅘”, the characteristic D3 corresponds to the case where the radius “a” is “a1×⅗”, and the characteristic D4 corresponds to the case where the radius “a” is “a1×⅖”. Thus, as the radius “a” of the vibrating portion 143 decreases, it becomes possible to obtain flat and sufficient sensitivity over a higher frequency band.

On the other hand, when the radius “a” of the vibrating portion 143 is reduced, the rigidity of the vibrating portion 143 increases. In this case, since the vibrating portion 143 becomes hard to vibrate, the sensitivity tends to decrease. To prevent the decrease in sensitivity, there are a method of increasing a bias voltage applied to the acoustic signal-electric signal converting portion Cm1, a method of reducing the thickness “b” of the vibrating portion 143 in a range where the fundamental resonance frequency “fo” of the vibrating portion 143 is not decreased, and a method of changing the gap between the vibrating portion 143 and the lower electrode 141. Alternatively, when a plurality of fine apertures (not shown) for passing the air are formed in the lower electrode 141, acoustic characteristics may be adjusted by controlling acoustic resistance with the fine apertures.

Therefore, in the above-described wiring system, when the first microphone 104 of the intercom unit 7 can detect an ultrasonic acoustic signal emitted from an ultrasonic remote controller, a control signal for a lighting apparatus, an air conditioning apparatus or the like can be generated in the processing section 88. By transmitting this control signal to the lighting apparatus or the air conditioning apparatus through the information line L2, it becomes possible to turn on/off the apparatus, adjust a light amount of the lighting apparatus, or control indoor temperature.

### INDUSTRIAL APPLICABILITY

As understood from the above embodiments, the voice information processing device of the present invention is excellent in howling preventing effect, and provides a reduction in size of the device as a whole. In addition, the wiring system, in which the intercom device having the voice information processing device therein can be detachably used, is excellent in function expandability and easy exchangeability. As a result, a general user can easily perform a layout change of the intercom device in the wiring system and an operation of adding another function unit(s) to the wiring system without troublesome work. Thus, a comfortable and convenience wiring system that meets the needs of individual users can be constructed with an increased degree of freedom of design.

1. A voice information processing device comprising:
a speaker having a diaphragm for outputting voice information;
a pair of first and second microphones each having a sound collecting portion; and
a signal processing portion configured to process output signals of said first and second microphones;
wherein said first microphone is disposed to face the diaphragm of said speaker, and said second microphone is disposed outside of an outer periphery of the diaphragm of said speaker,
wherein said signal processing portion reduces an output voice component of said speaker contained in the output signal of said second microphone by use of the output signal of said first microphone.

2. The voice information processing device as set forth in claim 1, further comprising a housing configured to accommodate therein said speaker and said first microphone, and having sound passing holes for providing the voice information output from said speaker to the outside,
wherein said speaker is disposed in said housing such that the diaphragm faces said sound passing holes, and
said first microphone is held between said sound passing holes and the diaphragm such that said sound collecting portion of said first microphone faces the diaphragm.

3. The voice information processing device as set forth in claim 2, wherein said speaker is held by a first rib formed on an inner surface of said housing around said sound passing holes, and said first microphone is held by a second rib formed on the inner surface of said housing to face a substantially center portion of the diaphragm.

4. The voice information processing device as set forth in claim 1, wherein at least one of said first and second microphones comprises an acoustic sensor element, a voltage applying circuit configured to apply a bias voltage to said acoustic sensor element, an impedance conversion circuit configured to convert an electrical impedance of a microphone output, and an electromagnetic shield case for accommodating therein said acoustic sensor element, said voltage applying circuit and said impedance conversion circuit.

5. The voice information processing device as set forth in claim 4, wherein said acoustic sensor element has a bare chip structure comprising a substrate, a lower electrode formed on said substrate, an insulating layer formed on said lower electrode, an upper electrode integrally formed with a vibrating portion having a plurality of apertures, and an electrode holding portion formed on said insulating layer to hold said upper electrode such that said vibrating portion is spaced away from said lower electrode by a clearance.

6. The voice information processing device as set forth in claim 5, further comprising a ventilation hole penetrating through said substrate and said lower electrode at a position facing a substantially center of said vibrating portion.

7. The voice information processing device as set forth in claim 1, wherein said signal processing portion comprises:
a signal level adjusting means configured to perform a signal level adjustment between the output signals of said first and second microphones;
a delay means configured to match phases of the output signals of said first and second microphones to each other according to a difference between a distance between said first microphone and said speaker and a distance between said second microphone and said speaker; and
a calculation means configured to cancel out the output voice component of said speaker in the output signal of said second microphone by use of the output signals of said first and second microphones obtained through said signal level adjusting means and said delay means.

8. The voice information processing device as set forth in claim 7, wherein said signal level adjusting means is an amplifying means configured to amplify the output signal of said second microphone to perform the signal level adjustment between the output signals of said first and second microphones.

9. The voice information processing device as set forth in claim 8, wherein said calculation means cancels out the output voice component by subtracting between the output signals of said first and second microphones obtained though said amplifying means and said delay means.

10. The voice information processing device as set forth in claim 8, wherein said amplifying means inversely amplifies the output signal of said second microphone, and said calculation means cancels out the output voice component by adding the output signals of said first and second microphones obtained though said amplifying means and said delay means.

11. The voice information processing device as set forth in claim 7, wherein said signal processing portion has a filtering means configured to extract only a signal of a predetermined voice band from each of the output signals of said first and second microphones.

12. The voice information processing device as set forth in claim 1, further comprising a housing configured to accommodate therein said speaker and said first microphone, and having sound passing holes for providing the voice information to the outside,
wherein said speaker is disposed in said housing such that the diaphragm faces said sound passing holes, and
said first microphone is disposed at a side opposite to the side facing said sound passing holes with respect to the diaphragm.

13. The voice information processing device as set forth in claim 12, wherein said speaker comprises a tubular partition wall disposed at a rear surface of the diaphragm to accommodate therein said first microphone, a voice coil, and a permanent magnet, which are disposed outside of said tubular partition wall.

14. The voice information processing device as set forth in claim 12, wherein said first microphone is disposed such that its sound collecting portion faces a rear surface of the diaphragm.

15. The voice information processing device as set forth in claim 1, wherein said speaker comprises:
a first magnet disposed such that a magnetic pole facing the diaphragm is either one of N and S poles thereof;
a second magnet disposed around said first magnet so as to have a magnetic pole facing the diaphragm different from the magnetic pole facing the diaphragm of said first magnet;
magnetic materials disposed on both end surfaces of said first magnet and said second magnet; and
a voice coil accommodated in a groove formed at a position corresponding to a boundary portion between said first and second magnets in one of said magnetic materials, which is located between the diaphragm and said first magnet and said second magnet.

16. The voice information processing device as set forth in claim 15, wherein said speaker has a ventilation hole penetrating through said first magnet and said magnetic materials at a position facing a substantially center of the diaphragm.

17. The voice information processing device as set forth in claim 15, wherein said speaker has a third magnet, which is disposed between said first magnet and said second magnet such that a magnetic pole facing said first magnet of said third magnet is equal to the magnetic pole facing the diaphragm of said first magnet, and a magnetic pole facing said second magnet of said third magnet is equal to the magnetic pole facing the diaphragm of said second magnet, and said voice coil is accommodated in said groove formed above said third magnet in the one of said magnetic materials.

18. The voice information processing device as set forth in claim 1, wherein said speaker comprises:
a first multilayer magnet member formed in layers by a plurality of magnets;
a second multilayer member formed in layers by a plurality of magnets, and disposed around said first multilayer magnet member through a groove;
a bottom magnet disposed at a bottom of said groove between said first multilayer magnet member and said second multilayer magnet member; and
a voice coil disposed in a top opening of said groove,
wherein magnetic flux passes through said first multilayer magnet member, said bottom magnet, said second multilayer magnet member and said coil voice in a loop-like manner.

19. A wiring system using the voice information processing device as set forth in claim 1, the wiring system comprising:
a base unit adapted in use to be mounted in a wall surface of a building structure, and connected to both of an electric power line and an information line installed in said building structure;
a function unit configured to provide at least one of functions of supplying electric power from said electric power line, outputting information from said information line, and inputting information into said information line when connected to said electric power line and said information line through said base unit; and
an intercom unit including the voice information processing device, said intercom unit detachably connected to one of said function unit and said base unit, and comprising a power transmission means configured to enable power transmission with one of said base unit and said function unit, and a signal transmission means configured to enable signal transmission therewith,
wherein a voice signal provided from said signal transmission means is output from said speaker, and a voice signal input from said second microphone is sent to said information line through said signal transmission means.

20. The wiring system as set forth in claim 19, wherein said power transmission means enables the power transmission between said intercom unit and one of said base unit and said function unit by means of electromagnetic coupling.

21. The wiring system as set forth in claim 19, wherein said signal transmission means enables the signal transmission between said intercom unit and one of said base unit and said function unit by means of optical coupling.

22. The wiring system as set forth in claim 19, wherein said intercom unit and one of said base unit and said function unit have a pair of a module port and a module connector, which are detachably connected to each other to simultaneously establish both of the power transmission therebetween and the signal transmission therebetween.

23. The wiring system as set forth in claim 22, wherein one of said module connector and said module port is formed at a side of said intercom unit such that said intercom unit is detachably connected to one of said base unit and said function unit in a direction along said wall surface.

24. The wiring system as set forth in claim 22, wherein said module connector and said module port have a pair of an electric power connector and an electric power port, which are detachably connected to each other to enable the power transmission by means of electromagnetic coupling, and a pair of a signal connector and a signal port, which are detachably connected to each other to enable the signal transmission by means of optical coupling.

25. The wiring system as set forth in claim 19, further comprising a cosmetic frame disposed along said wall surface, and having an opening, to which said intercom unit and said function unit are detachably attached.

26. The wiring system as set forth in claim 19, comprising a first engaging portion formed in one of said base unit and said function unit, a second engaging portion formed in said intercom unit, and a joining member configured to make a mechanical connection between said intercom unit and one of said base unit and said function unit when a part of said joining member is engaged to said first engaging portion, and the remaining part of said joining member is engaged to said second engaging portion.

27. The wiring system as set forth in claim 19, further comprising an additional function unit detachably connected to said function unit, and wherein said additional function unit is configured to provide at least one of functions of supplying electric power from said electric power line, outputting information from said information line, and inputting information into said information line when connected to said electric power line and said information line through said base unit and said function unit.

28. The wiring system as set forth in claim 27, wherein said intercom unit is detachably connected at its one side to said function unit, detachably connected at the other side to said additional function unit, and has a second power transmission means configured to enable power transmission with said additional function unit, and a second signal transmission means configured to enable signal transmission therewith.

29. A wiring system using the voice information processing device as set forth in claim 1, the wiring system comprising:
a base unit adapted in use to be mounted in a wall surface of a building structure, and connected to an electric power line installed in said building structure;
a function unit configured to provide at least one of functions of supplying electric power from said electric power line, outputting information carried by use of said electric power line, and inputting information to be carried into said electric power line when connected to said electric power line through said base unit; and
an intercom unit including the voice information processing device;
wherein at least one of said base unit, said function unit and said intercom unit has a transmitting and receiving means configured to enable transmitting and receiving of information signals by means of power line communication,
said intercom unit is detachably connected to one of said function unit and said base unit, and comprises a power transmission means configured to enable power transmission with one of said base unit and said function unit, and a signal transmission means configured to enable signal transmission therewith, and
when said intercom unit is connected to said electric power line through said base unit or through said base unit and said function unit, voice information received from said electric power line by said transmitting and receiving means is output from said speaker, and voice information input from said second microphone is transmitted in a power line communication manner through said transmitting and receiving means.
